(19) United States
(12) Patent Application Publication
(10) Pub. No.: US 2014/0348039 A1
(43) Pub. Date: Nov. 27, 2014

(54) METHOD AND DEVICE FOR TRANSRECEIVING CELL-SELECTIVE SIGNALS IN MULTICOMPONENT CARRIER SYSTEM

(71) Applicant: Pantech Co., Ltd., Seoul (KR)

(72) Inventors: Dong Hyun Park, Seoul (KR); Ki Bum Kwon, Seoul (KR)

(21) Appl. No.: 14/361,298

(22) PCT Filed: Nov. 28, 2012
(86) PCT No.: PCT/KR2012/010185

§ 371 Date: May 28, 2014

(30) Foreign Application Priority Data
Nov. 29, 2011 (KR) 10 2011 0125806

(51) Int. Cl. H04W 72/04; H04L 5/14

(52) U.S. Cl. CPC H04W 72/042; H04L 5/14
USPC 370/280

(57) ABSTRACT

The present invention relates to a method and device for transreceiving cell-selective signals in a multi-component carrier system. The present invention provides a method for transreceiving cell-selective signals, and the method comprises the steps of: configuring, in a terminal, a sub serving cell belonging to a first band; setting one of the sub serving cell and a main serving cell as a mute serving cell and the other as a valid serving cell, in an inconsistent subframe in which a first TDD uplink/downlink configuration of the sub serving cell is different from a second TDD uplink/downlink configuration of the main serving cell belonging to a second band that is different from the first band; and transreceiving a scheduled signal to and from the set valid serving cell.

### CROSS-REFERENCE TO RELATED APPLICATIONS

This application is the National Stage Entry of International Application No. PCT/KR2012/010185, filed on Nov. 28, 2012 and claims the benefit of priority of Korean Patent Application No. 10-2011-0125806, filed on Nov. 29, 2011, both of which are hereby incorporated by reference for all purposes as if fully set forth herein.

### BACKGROUND

1. Field

The preset invention relates to a wireless communication, and more particularly, to a device and a method for transceiving cell selective signals in a multi-component carrier system.

2. Discussion of the Background

Radio resources used in a wireless communication are generally defined in a frequency domain, a time domain, and a code domain. In the wireless communication, each of user equipment (UE) and a base station (BS) needs to use given radio resources. A wireless path through which the UE transmits data to the BS is referred to as an uplink and a wireless path through which the BS transmits data to the UE is referred to as a downlink. Meanwhile, a scheme is required, which divides radio resources in downlink transmission and radio resources used in uplink transmission not to be overlapped with each other and such a scheme is referred to as duplex.

The uplink and the downlink may be divided in the frequency, time, and code domains similarly as in a multiple access scheme for dividing different users. The duplex scheme is generally divided into a frequency division duplex (FDD) that divides the uplink and the downlink by a frequency and a time division duplex (TDD) scheme that divides the uplink and the downlink by time. The TDD is one of half-duplex schemes in which only uni-directional communication is permitted.

In the FDD scheme, since the uplink and the downlink are divided in the frequency domain, data may be consecutively transmitted between the UE and the BS in each link in the time domain. Since frequencies having the same size are symmetrically allocated to the uplink and the downlink in the FDD scheme, the FDD scheme is proper to a symmetric service such as a voice call to be a lot used in the symmetric service. However, in recent years, since the TDD scheme is proper to an asymmetric service such as an Internet service, the TDD scheme has been actively researched.

Since time slots having different ratios may be allocated to the uplink and the downlink, the TDD scheme is advantageous in being proper to the asymmetric service. Another advantage of the TDD scheme is that since the uplink and the downlink are transceived in the same frequency band, channel statuses of the uplink and the downlink almost coincide with each other. Therefore, since the channel status may be immediately estimated when a signal is received, the TDD scheme is proper to an array antenna technology, and the like. In the TDD scheme, the entire frequency band is used as the uplink or downlink, however, the uplink and the downlink are divided in the time domain, and as a result, the frequency is used as the uplink during a predetermined time and as the downlink during another predetermined time. Therefore, data may not be simultaneously transmitted and received between the UE and the BS.

A multiple component carrier system supports a plurality of component carriers (CCs) divided in the frequency domain. When different inter-band components carriers are aggregated, different TDD uplink/downlink configurations may be allocated to respective component carriers. As a result, a predetermined subframe may be an uplink subframe for a first component carrier, but the predetermined subframe may be a downlink subframe for a second component carrier. According to the half-duplex scheme, the predetermined subframe needs to operate as only a uni-directional subframe. However, when transmission on the first component carrier and reception on the second component carrier or reception on the first component carrier and transmission on the second component carrier collide with each other, an unstable operation of the system may be caused.

### SUMMARY

An object of the present invention is to provide a device and a method for transceiving a cell selective signal in a multiple component carrier system.

Another object of the present invention is to provide a device and a method for transceiving a cell selective signal in an inconsistent subframe of a system that supports a half-duplex mode.

Yet another object of the present invention is to provide a device and a method for selecting a muted serving cell in an inconsistent subframe of a system that supports a half-duplex mode.

Yet another object of the present invention is to provide a device and a method for transmitting muted serving cell information used to select a serving cell in an inconsistent subframe of a system that supports a half-duplex mode.

Yet another object of the present invention is to provide a device and a method for transmitting a subframe indicator used to select a serving cell in an inconsistent subframe of a system that supports a half-duplex mode.

In accordance with an aspect of the present invention, there is provided a method for transceiving a cell selective signal by a user equipment in a multiple element carrier system in which an uplink and a downlink are subjected to time division duplex (TDD) by the unit of a subframe. The method includes: configuring a secondary serving cell that belongs to a second band other than a first band to which a primary serving cell belongs; setting one of the secondary serving cell and the primary serving cell as a muted serving cell and the other one as an effective serving cell in a predetermined subframe when the predetermined subframe is set by transmission links in different directions with respect to the primary serving cell and the secondary serving cell; and performing transmission and reception of a signal on the set effective serving cell.

In accordance with another aspect of the present invention, there is provided a method for transceiving a selective signal by a base station in a multiple element carrier system in which an uplink and a downlink are subjected to time division duplex by the unit of a subframe. The method includes: transmitting an RRC message that makes a secondary serving cell that belongs to a second band other than a first band to which a primary serving cell belongs in a user equipment and muted serving cell information, to the user equipment; setting one of the secondary serving cell and the primary serving cell as a muted serving cell and the other one as an effective serving cell in a predetermined subframe based on the muted serving cell information when the predetermined subframe is set by transmission links in different directions with respect to the primary serving cell and the secondary serving cell; and performing transmission and reception of a scheduled signal on the effective serving cell.

According to the present invention, when inter-band carrier aggregation is achieved in a TDD system, the user equipment and the base station may implement a stable operation even on the inconsistent subframe by using the muted serving cell information and the muted serving cell selection rule.

### BRIEF DESCRIPTION OF THE DRAWINGS

FIG. 1 illustrates a wireless communication system according to the present invention.

FIG. 2 illustrates another example of a radio frame structure according to the present invention. The radio frame structure is a TDD radio frame structure.

FIG. 3 is a diagram describing a state of the serving cells configured in the user equipment in the multiple component carrier system according to an embodiment of the present invention.

FIG. 4 is an explanatory diagram showing a difference in the TDD uplink/downlink configuration between the serving cells in the inter-band carrier aggregation in the half-duplex mode according to an embodiment of the present invention.

FIG. 5 is an explanatory diagram describing a method for applying a TDD uplink/downlink configuration in a multiple component carrier system according to another example.

FIG. 6 is an explanatory diagram describing a method for transceiving a cell selective signal in an inconsistent subframe according to one example.

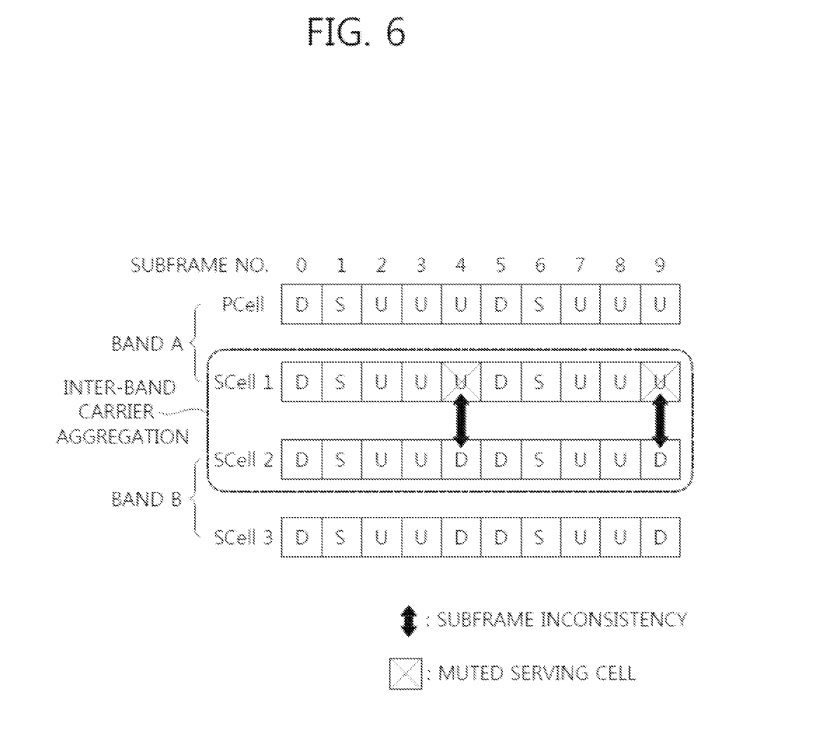

FIG. 7 is an explanatory diagram describing a muted serving cell selection rule according to an example of the present invention.

FIG. 8 is an explanatory diagram describing a muted serving cell selection rule according to another example of the present invention.

FIG. 9 is an explanatory diagram describing a muted serving cell selection rule according to yet another example of the present invention.

FIG. 10 is an explanatory diagram describing a muted serving cell selection rule according to yet another example of the present invention.

FIG. 11 is an explanatory diagram describing a muted serving cell selection rule according to yet another example of the present invention.

FIG. 12A is an explanatory diagram describing a method for controlling a TDD uplink/downlink configuration of a band according to one example.

FIG. 12B is an explanatory diagram describing a method for controlling a TDD uplink/downlink configuration of a band according to another example.

FIG. 13 is an operational flowchart for describing a muting start point according to one example of the present invention.

FIG. 14 is an operational flowchart for describing the muting start point according to another example of the present invention.

FIG. 15 is an explanatory diagram describing a muted serving cell selection rule according to yet another example of the present invention.

FIG. 16 is an explanatory diagram describing a muted serving cell selection rule according to yet another example of the present invention.

FIG. 17 is a block diagram illustrating a user equipment and a base station according to one example.

### DETAILED DESCRIPTION OF THE ILLUSTRATED EMBODIMENTS

Herein, some embodiments will be described in detail with reference to the accompanying drawings in the present invention. When reference numerals refer to components of each drawing, it is to be noted that although the same components are illustrated in different drawings, the same components are referred to by the same reference numerals as possible. In describing the embodiments of the present invention, when it is determined that the detailed description of the known art related to the present invention may obscure the gist of the present invention, the detailed description thereof will be omitted.

Further, the specification primary describes a wireless communication network, and a task performed in the wireless communication network may be achieved during a process controlling the network and transmitting data in a system (for example, a base station) that controls the corresponding wireless communication network or the task may be achieved in a user equipment joined to the corresponding wireless network.

According to embodiments of the present invention, a meaning ‘transmitting a control channel’ may be analyzed as a meaning that control information is transmitted through a specific channel. Herein, the control channel may be, for example, a physical downlink control channel (PDCCH) or a physical uplink control channel (PUCCH).

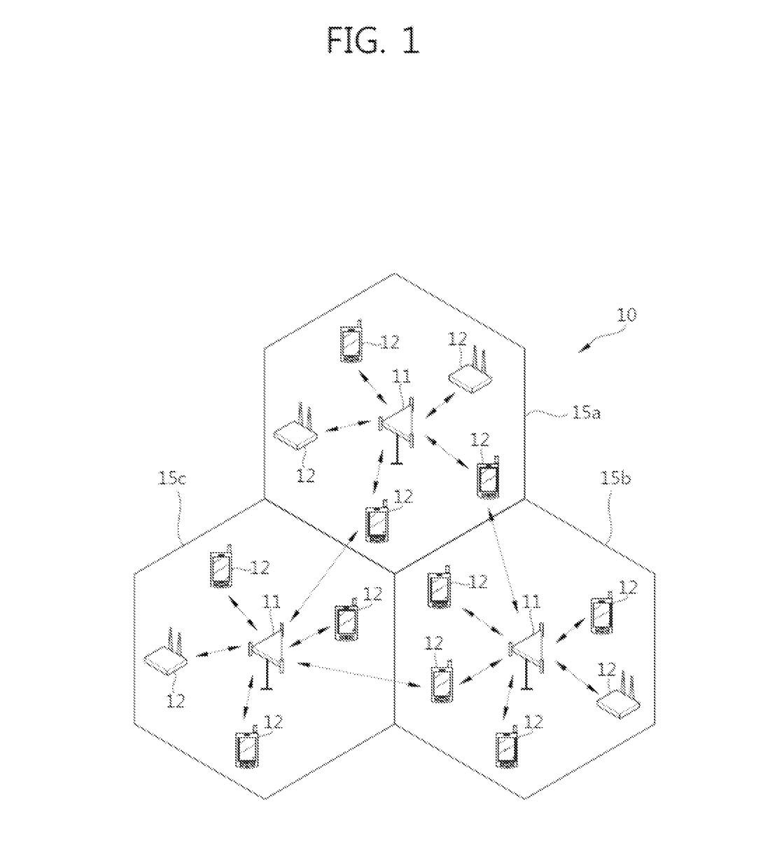

FIG. 1 illustrates a wireless communication system according to the present invention.

Referring to FIG. 1, the wireless communication system 10 is widely placed to provide various communication services such as voice, packet data, and the like. The wireless communication system 10 includes at least one base station (BS) 11. Each base station 11 provides a communication service to specific cells 15a, 15b, and 15c. The cell may be redivided into a plurality of sectors. The base station 11 may be called other terms such as an evolved-NodeB (eNBb), a base transceiver system (BTS), an access point, a femto base station, a home nodeB, a relay, and the like. The cell represents a meaning including all of various coverage sectors such as a mega cell, a macro cell, a micro cell, a pico cell, a femto cell, and the like.

The user equipment (UE) 12 may be fixed or movable and may be called other terms such as a mobile station (MS), a mobile terminal (MT), a user terminal (UT), a subscriber station (SS), a wireless device, a personal digital assistant (PDA), a wireless modem, a handheld device, and the like.

Hereinafter, a downlink represents a transmission link toward the user equipment 12 in the base station 11 and a downlink represents a transmission link toward the base station 11 in the user equipment 12. In the downlink, a transmitter may be a part of the base station 11 and a receiver may be a part of the user equipment 12. In the uplink, the transmitter may be a part of the user equipment 12 and the receiver may be a part of the base station 11. A multiple access technique applied to the wireless communication system is not limited. Various multiple access techniques may be used, such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and OFDM-CDMA. The time division duplex (TDD) scheme in which transmission is performed by different times or the frequency division duplex (FDD) scheme in which transmission is performed by using different frequencies may be used for the uplink transmission and the downlink transmission.

Carrier aggregation (CA) as a communication scheme in which a plurality of carriers is supported is also referred to as spectrum aggregation or bandwidth aggregation. Individual unit carriers aggregated by the carrier aggregation are referred to as component carriers (CCs). Each component carrier is defined by a bandwidth and a center frequency. The carrier aggregation is introduced to support an increased throughput, prevent a cost increase caused due to a wideband radio frequency (RF) element and ensure compatibility with the existing system. For example, when five component carriers are allocated as granularity of the unit of the carrier having a bandwidth of 20 MHz, a bandwidth of maximum 100 MHz may be supported.

The carrier aggregation may be divided into contiguous carrier aggregation which is achieved between consecutive component carriers and non-contiguous carrier aggregation which is achieved between inconsecutive component carriers in the frequency domain. The numbers of aggregated carriers of the downlink and the uplink may be set to be different from each other. A case in which the number of the downlink component carriers and the number of uplink component carriers are the same as each other is referred to as symmetric aggregation and a case in which the numbers are different from each other is referred to as asymmetric aggregation.

The sizes (that is, bandwidths) of the component carriers may be different from each other. For example, when it is assumed that five component carriers are used to configure a 70 MHz-band, the 70 MHz-band may be configured by 5 MHz component carrier (carrier #0), 20 MHz component carrier (carrier #1), 20 MHz component carrier (carrier #2), 20 MHz component carrier (carrier #3), and 5 MHz component carrier (carrier #4).

Hereafter, the multiple carrier system represents a system that supports the carrier aggregation. In the multiple carrier system, the contiguous carrier aggregation and/or the non-contiguous carrier aggregation and further, either of the symmetric aggregation and the asymmetric aggregation may be used. A serving cell may be defined as a component frequency band which may be aggregated by the carrier aggregation based on a multiple component carrier system. The serving cell includes a primary serving cell (PCell) and a secondary serving cell (SCell). The primary serving cell represents one serving cell that provides a security input and NAS mobility information in an RRC establishment or re-establishment state. According to capabilities of the user equipment, at least one cell may be configured to form a set of serving cells together with the primary serving cell and the at least one cell is referred to as the second serving cell. A set of serving cells set for one user equipment may be configured by only one primary serving cell or by one primary serving cell and at least one secondary serving cell.

A downlink component carrier corresponding to the primary serving cell is referred to as a downlink primary component carrier (DL PCC) and an uplink component carrier corresponding to the primary serving cell is referred to as an uplink primary component carrier (UL PCC). Further, in the downlink, a component carrier corresponding to the secondary serving cell is referred to as a downlink secondary component carrier (DL SCC) and in the uplink, a component carrier corresponding to the secondary serving cell is referred to as an uplink secondary component carrier (UL SCC). Only the downlink component carrier may correspond to one serving cell and both DL CC and the UL CC may correspond to one serving cell.

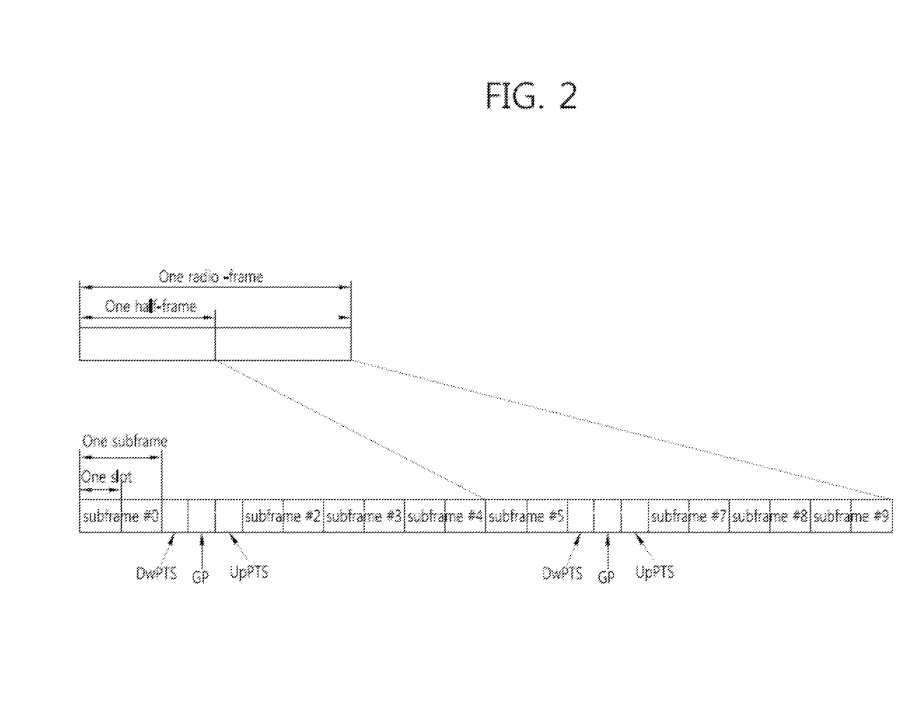

FIG. 2 illustrates another example of a radio frame structure according to the present invention. The radio frame structure is a TDD radio frame structure.

Referring to FIG. 2, the radio frame includes two half-frames. Structures of the respective half-frame are the same as each other. The half frame includes five subframes, three fields of a downlink pilot time slot (DwPTS), a guard period, and an uplink pilot time slot (UpPTS). The DwPTS is used in initial cell search, synchronization, or channel estimation in the user equipment. The UpPTS is used to match channel estimation in the base station and uplink transmission synchronization of the user equipment. The guard period is a period for removing an interference which occurs in the uplink due to a multipath delay of the downlink signal between the uplink and the downlink.

Table 1 illustrates one example of the TDD uplink/downlink (UL/DL) configuration of the radio frame. The TDD uplink/downlink configuration defines a subframe reserved for the uplink transmission and a subframe reserved for the uplink transmission in one radio frame. That is, the TDD uplink/downlink configuration indicates by which rule the uplink and the downlink are allocated (reserved) to all subframes in one radio frame.

TABLE 1

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Referring to Table 1, ‘D’ represents that the subframe is used for the downlink transmission and ‘U’ represents that the subframe is used for the uplink transmission. ‘S’ represents that the subframe is used for a special purpose and used for matching frame synchronization or the downlink transmission. Hereinafter, the subframe used for the downlink transmission is simply referred to as a downlink subframe and the subframe used for the uplink transmission is simply referred to as an uplink subframe. Positions and the numbers of the downlink subframes and the uplink subframes in one radio frame are different from each other for each TDD uplink/downlink configuration.

A point when the downlink is changed to the uplink or a point when the uplink is changed to the downlink is referred to as a switching point. Switch-point periodicity represents a cycle when an aspect in which the uplink subframe and the downlink subframe are switched are similarly repeated and is 5 ms or 10 ms. For example, from the viewpoint of TDD uplink/downlink 0, D->S->U->U->U are switched in 0-th to 4-th subframes and D->S->U->U->U are switched in 5-th to 9-th subframes similarly as before. Since one subframe is 1 ms, the switch-point periodicity is 5 ms. That is, the switch-point periodicity is smaller than one radio frame length (10 ms) and an aspect in which the uplink subframe and the downlink subframe are switched in the radio frame is repeated once.

The TDD uplink/downlink configuration of Table 1 may be transmitted from the base station to the user equipment through system information. The base station transmits only an index of the TDD uplink/downlink configuration whenever the TDD uplink/downlink configuration is changed to notify to the user equipment a change of an uplink-downlink allocation status of the radio frame. Alternatively, the TDD uplink/downlink configuration may be control information commonly transmitted to all user equipment in the cell through a broadcast channel as broadcast information.

The multiple component carrier system operates a plurality of serving cells including the primary serving cell and/or the secondary serving cell. Accordingly, in a half-duplex mode, the plurality of serving cells set in the user equipment may independently take the TDD uplink/downlink configuration. The TDD uplink/downlink configuration of the primary serving cell defines the uplink subframe reserved for the uplink transmission of the primary serving cell and the downlink subframe reserved for the downlink transmission of the primary serving cell. The TDD uplink/downlink configuration of the secondary serving cell defines the uplink subframe reserved for the uplink transmission of the secondary serving cell and the downlink subframe reserved for the downlink transmission of the secondary serving cell. For example, it is assumed that the TDD uplink/downlink configuration of the primary serving cell is No. 2 and the TDD uplink/downlink configuration of the secondary serving cell is No. 5 in Table 1 shown above. In this case, subframe #7 is the uplink subframe for the primary serving cell or the downlink subframe for the secondary serving cell.

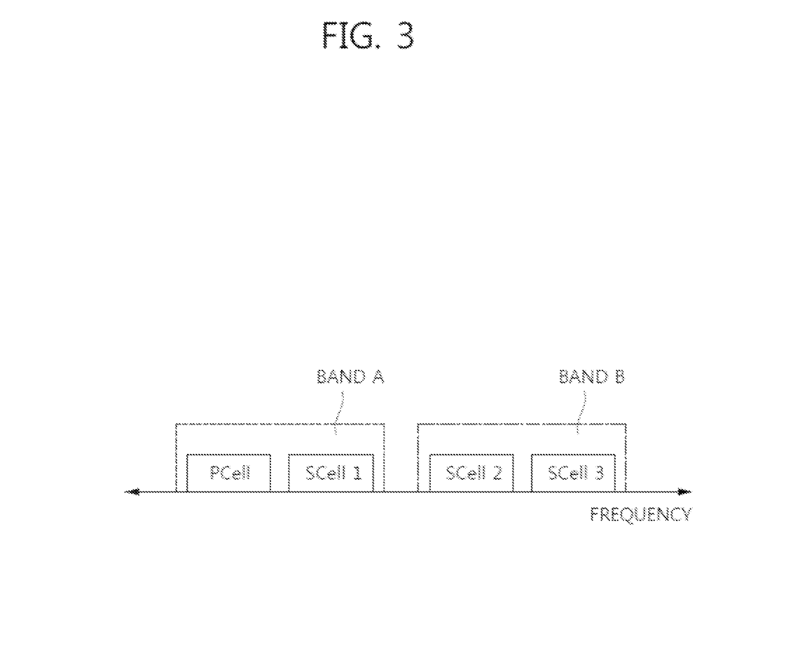

FIG. 3 is a diagram describing an exemplary state of the serving cells configured in the user equipment in the multiple component carrier system according to an embodiment of the present invention.

Referring to FIG. 3, a system bandwidth includes bands A and B, and the band A includes the primary serving cell PCell and a first secondary serving cell SCell 1 and the band B includes a second secondary serving cell SCell 2 and a third secondary serving cell SCell 3. Carrier aggregation of the primary serving cell and the first secondary serving cell is A intra-band aggregation. Similarly, carrier aggregation of the second secondary serving cell and the third secondary serving cell is B intra-band aggregation. On the contrary, carrier aggregation of the first primary serving cell and the second secondary serving cell is inter-band aggregation. In the intra-band aggregation, all serving cells in the same band need to have the same TDD uplink/downlink configuration, but in the inter-band carrier aggregation, serving cells in different bands in different bands may have different TDD uplink/downlink configurations. In the case of a full-duplex mode, there is no problem, but in the half-duplex mode, a problem may occur.

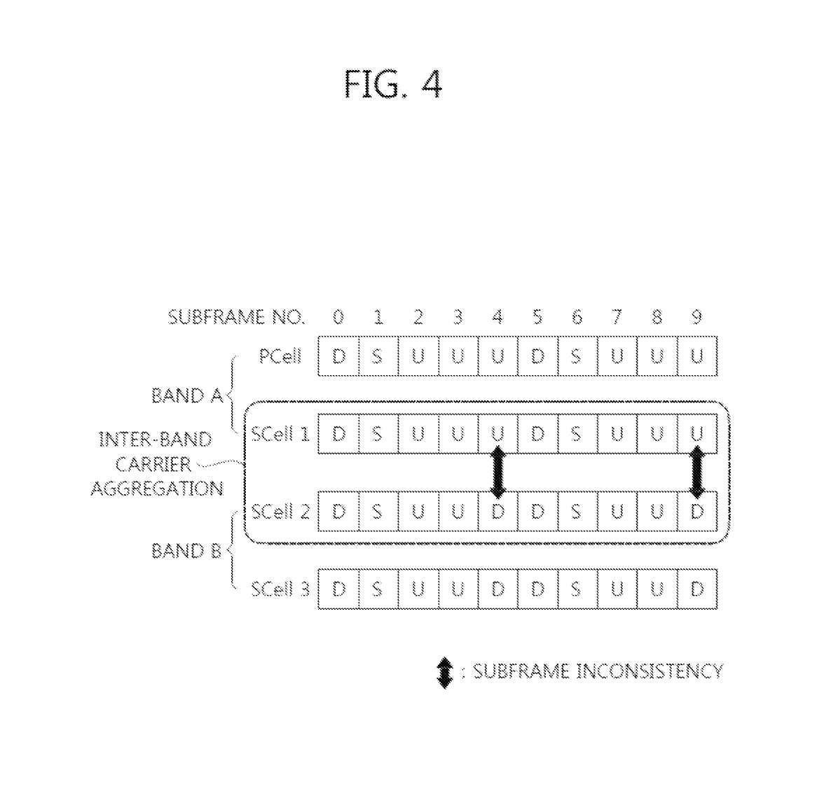

FIG. 4 is an explanatory diagram showing a difference in the TDD uplink/downlink configuration between the serving cells in the inter-band carrier aggregation in the half-duplex mode according to an embodiment of the present invention. This is described based on FIG. 3.

Referring to FIG. 4, the same TDD uplink/downlink configuration is applied to the serving cells included in the same band and the TDD uplink/downlink configuration is applied to different bands independently from each other. The TDD uplink/downlink configuration is also referred to as a band-specific TDD uplink/downlink configuration. The TDD uplink/downlink configuration #0 is applied to both the primary serving cell and the first secondary serving cell included in the band A and the TDD uplink/downlink configuration #1 is applied to both the second secondary serving cell and the third secondary serving cell included in the band B.

When the carrier aggregation is achieved between the first secondary serving cell and the second secondary serving cell, the carrier aggregation becomes the inter-band carrier aggregation. Of course, the carrier aggregation between the primary serving cell and the second secondary serving cell, the carrier aggregation between the primary serving cell and the third secondary serving cell, and the carrier aggregation between the first secondary serving cell and the third secondary serving cell also become the inter-band carrier aggregation. In the case of the TDD uplink/downlink configurations of the first secondary serving cell and the second secondary serving cell, other subframes are consistent, but subframes #4 and #9 of the first secondary serving cell are the uplink subframes, whereas subframes #4 and #9 of the second secondary serving cell are the downlink subframes. That is, from the viewpoint of the half-duplex mode, subframe inconsistency occurs in subframes #4 and #9 in terms of the TDD uplink/downlink configuration. The subframe inconsistency represents a situation in which subframe transmission directions in two or more serving cells compared with each other are different from each other and the subframes #4 and #9 may be called inconsistent subframes.

According to the duplex mode, an operation of the user equipment for the subframe inconsistency varies. For example, in the case of the full-duplex mode, the user equipment may perform the uplink transmission onto the first secondary serving cell and downlink reception onto the second secondary serving cell in the subframes #4 and #9. On the contrary, in the half-duplex mode, since communication is available in only any one direction, the user equipment selects only any one of the first secondary serving cell and the second secondary serving cell in the subframe #4 and performs communication with the base station through the selected secondary serving cell. Similarly, the user equipment selects only any one of the first secondary serving cell and the second secondary serving cell in the subframe #9 and performs communication with the base station through the selected secondary serving cell. Since remaining subframes other than the subframes #4 and #9 are configured in the same direction, the user equipment may perform communication through all secondary serving cells without the need of selecting any one serving cell.

When any one secondary serving cell is selected as effective in the subframes #4 and #9, scheduled communication is performed on only the effective secondary serving cell. On the contrary, the scheduled communication is not performed on a secondary serving cell which is not selected as effective, this case is referred to as mute or drop. Hereinafter, the serving cell selected as effective will be referred to as an effective serving cell and the serving cell not selected as effective will be referred to as a muted serving cell (SCell). The effective serving cell and the muted serving cell are included in different bands, are operated by the inter-band carrier aggregation, and need to be divided in the inconsistent subframe.

First, a principle for the user equipment or the base station to select the effective serving cell and the muted serving cell will be described in detail.

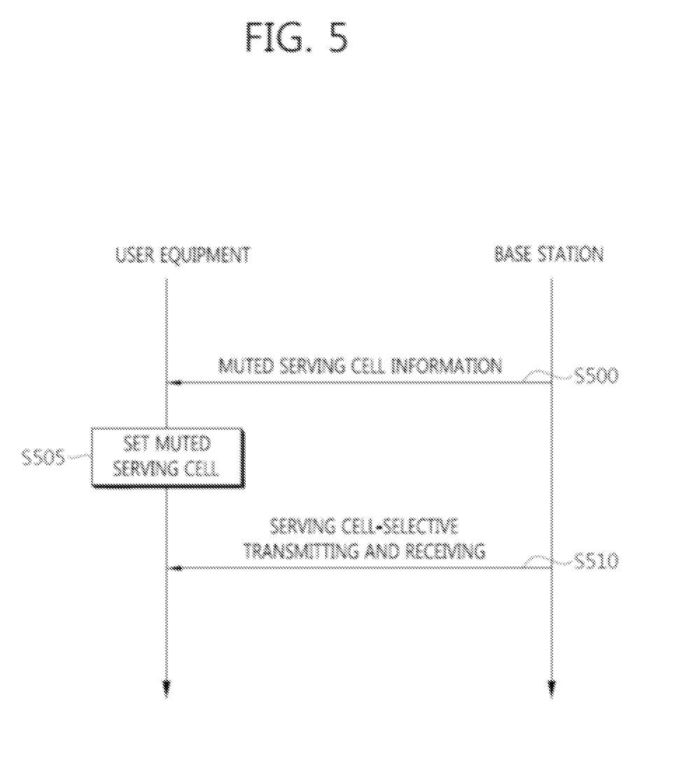

FIG. 5 is an operational flowchart of the user equipment and the base station in the inter-band carrier aggregation in the half-duplex mode according to an embodiment of the present invention.

Referring to FIG. 5, the base station transmits muted serving cell information (muted SCell infor) to the use equipment (S500). Herein, at least one serving cell has been constituted in the user equipment. The muted serving information notifies a muted serving cell in an inconsistent subframe to the user equipment.

As one example, the muted serving cell information as UE-specific transmitted information may be included in a radio resource control (RRC) message. For example, the RRC message may be an RRC establishment reconfiguration message used in a procedure of reconfiguring a secondary serving cell, such as addition, removable, or the like of the secondary serving cell or an RRC message dedicatedly transmitted to each user equipment, not a situation in which the secondary serving cell is added. Even in any case, the RRC message may be a radio resource configuration common secondary serving cell information element (RadioResourceConfigCommonSCell information element) constituted by a syntax shown in Table 2.

TABLE 2

| | |
|---|---|
| RadioResourceConfigCommonSCell-r10 ::= | SEQUENCE { |

| -- DL configuration as well as configuration applicable for DL and UL | |
|---|---|
| nonUL-Configuration-r10 | SEQUENCE { |

| | |
|---|---|
| -- 1: Cell characteristics | |
| dl-Bandwidth-r10 | ENUMERATED {n6, n15, n25, |
| n50, n75, n100}, | |
| -- 2: Physical configuration, general | |
| antennaInfoCommon-r10 | AntennaInfoCommon, |

| | |
|---|---|
| mbsfn-SubframeConfigList-r10 | MBSFN-SubframeConfigList |

| | |
|---|---|
| OPTIONAL, | -- Need OR |

| -- 3: Physical configuration, control | |
|---|---|
| phich-Config-r10 | PHICH-Config, |
| -- 4: Physical configuration, physical channels | |
| pdsch-ConfigCommon-r10 | PDSCH-ConfigCommon, |

| | |
|---|---|
| tdd-Config-r10 | TDD-Config |

| | |
|---|---|
| OPTIONAL | -- Cond TDDSCell |

| | |
|---|---|
| }, | |
| -- UL configuration | |
| ul-Configuration-r10 | SEQUENCE { |

ul-FreqInfo-r10 SEQUENCE {

| | | |
|---|---|---|
| ul-CarrierFreq- | ARFCN-ValueEUTRA | OPTIONAL, -- |
| r10 | | |
| Need OP | | |
| ul-Bandwidth-r10 | ENUMERATED {n6, n15, | |

| | | |
|---|---|---|
| n25, n50, n75, n100} | OPTIONAL, | -- Need OP |

| | |
|---|---|
| additionalSpectrumEmissionSCell-r10 | AdditionalSpectrumEmission |
| }, | |

| | | |
|---|---|---|
| p-Max-r10 | P-Max | OPTIONAL, |
| -- Need OP | | |

uplinkPowerControlCommonSCell-r10

UplinkPowerControlCommonSCell-r10,

| -- A special version of IE UplinkPowerControlCommon may be introduced | |
|---|---|
| -- 3: Physical configuration, control | |
| soundingRS-UL-ConfigCommon-r10 | SoundingRS-UL-ConfigCommon, |
| ul-CyclicPrefixLength-r10 | UL-CyclicPrefixLength, |

| -- 4: Physical configuration, physical channels | |
|---|---|
| prach-ConfigSCell-r10 | PRACH-ConfigSCell-r10 |

| | |
|---|---|
| OPTIONAL, | -- Cond TDD-OR |

| | |
|---|---|
| pusch-ConfigCommon-r10 | PUSCH-ConfigCommon |

| | |
|---|---|
| } | |
| OPTIONAL, | -- Need OR |

...

}

Referring to Table 2, the radio resource configuration common secondary serving cell information element includes a TDD configuration information element (tdd-config IE). The TDD configuration information element is used to specify a specific physical channel configuration in TDD and in particular, may include muted serving cell information (MutedSCellHalfDuplex).

As another example, the mutes serving cell information may include system information (SI) on a primary serving cell. In this case, the muted serving cell information is cell-specific transmitted information. The system information may be, for example, system information block 1 (SIB 1) transmitted on the primary serving cell as shown in Table 3.

TABLE 3

| -- ASN1START | | |
|---|---|---|
| SystemInformationBlockType1 ::= | | SEQUENCE { |
| | cellAccessRelatedInfo | SEQUENCE { |

| | |
|---|---|
| plmn-IdentityList | PLMN-IdentityList, |
| trackingAreaCode | TrackingAreaCode, |
| cellIdentity | CellIdentity, |
| cellBarred | ENUMERATED {barred, |
| notBarred}, | |
| intraFreqReselection | ENUMERATED{allowed, |
| notAllowed}, | |

| | |
|---|---|
| csg-Indication | BOOLEAN, |

| | | |
|---|---|---|
| csg-Identity | CSG-Identity | OPTIONAL -- |
| Need OR | | |

| | |
|---|---|
| }, | |
| cellSelectionInfo | SEQUENCE { |

| | | |
|---|---|---|
| q-RxLevMin | Q-RxLevMin, | |
| q-RxLevMinOffset | INTEGER (1..8) | OPTIONAL -- |
| Need OP | | |

| | |
|---|---|
| }, | |
| p-Max | P-Max |

| | | | |
|---|---|---|---|
| OPTIONAL, | -- Need OP | | |
| freqBandIndicator | INTEGER (1..64), | | |
| schedulingInfoList | SchedulingInfoList, | | |
| tdd-Config | TDD-Config | OPTIONAL, | -- Cond |
| TDD | | | |
| si-WindowLength | ENUMERATED { | | |

ms1, ms2, ms5, ms10, ms15, ms20,
ms40},

| | |
|---|---|
| systemInfoValueTag | INTEGER (0..31), |
| nonCriticalExtension | SystemInformationBlockType1-v890-IEs |

OPTIONAL

}
-- ASN1STOP

Referring to Table 3, the system information block 1 includes a TDD configuration information element (tdd-config IE). The TDD configuration information element is used to specify a specific physical channel configuration in TDD and in particular, may include muted serving cell information (MutedSCellHalfDuplex). The base station transmits the muted serving cell information to the user equipment on the primary serving cell to implicitly indicate whether a secondary serving cell of another band is the muted serving cell in the inconsistent subframe.

As yet another example, the muted serving cell information may be included in downlink control information (DCI) mapped to a physical downlink channel. The number of user equipments connected to a pico cell, a home eNB, or a femto cell will be even smaller than the number of user equipments connected to a macro eNB. Accordingly, there may be wide variations in data traffic in coverage of the pico cell or the home eNB. Under such a traffic environment, it is necessary to make an adaptive data transceiving environment. To this end, the adaptive data transceiving environment may be provided to user equipments that operate in a half-duplex mode in the inconsistent subframe through a dynamic TDD uplink/downlink configuration change using a physical channel.

When the user equipment receives the muted serving cell information, the user equipment selects any one serving cell according to a predetermined selection rule between the user equipment and the base station among two or more carrier-aggregated serving cells and sets the selected serving cell as the muted serving cell (S505). Various embodiments of the selection rule may be achieved and will be described below.

When the muted serving cell is set, the user equipment does not perform scheduled transmission and reception on the muted serving cell every inconsistent subframe, but performs only the scheduled transmission and reception on an effective serving cell. That is, the user equipment performs cell selective signal transmission and reception (S510). For example, when a first secondary serving cell is the muted serving cell, the user equipment does not perform scheduled uplink transmission on the first secondary serving cell, but performs scheduled downlink reception on only a second secondary serving cell, subframes #4 and #9 which are the inconsistent subframes. However, although set as the muted serving cell, the user equipment may perform the scheduled transmission and reception eve on the muted serving cell in remaining subframes other than the inconsistent subframes.

Hereinafter, a selection rule of selecting the muted serving cell will be disclosed in detail.

### First Embodiment

### Rule of Selecting Muted Serving Cell Specific to Band

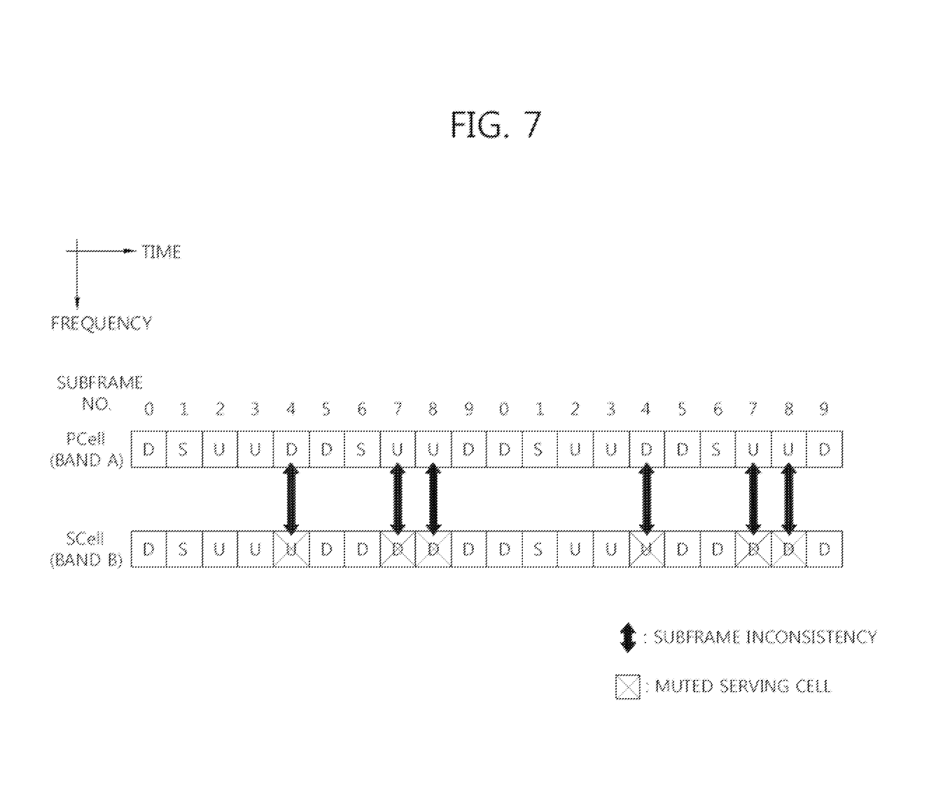

FIG. 7 is an explanatory diagram describing a muted serving cell selection rule according to an embodiment of the present invention.

Referring to FIG. 7, it is assumed that a primary serving cell (PCell) and a secondary serving cell (SCell) that belong to different bands A and B are configured by carrier aggregation, and the TDD uplink/downlink configuration #1 in Table 1 is applied to the primary serving cell and the TDD uplink/downlink configuration #3 in Table 1 is applied to the secondary serving cell. The inconsistent subframes are subframes #4, #7, and #8 of each radio frame.

By an instruction from the base station, the band B is set as a muting band the band A is implicitly as a non-muting band. The user equipment judges which one of the primary serving cell and the secondary serving cell is included in the muting band. Since the secondary serving cell is included in the muting band, the user equipment selects the secondary serving cell as the muted serving cell. In addition, since the primary serving cell is included in the non-muting band, the user equipment selects the primary serving cell as the effective serving cell.

As a result, the user equipment does not perform the scheduled uplink transmission on the secondary serving cell in every subframe #4 (that is, mutes the secondary serving cell), but performs only the scheduled downlink reception on the secondary serving cell. In addition, the user equipment does not perform the scheduled downlink reception on the secondary serving cell in every subframes #7 and #8 (that is, mutes the secondary serving cell), but performs only the scheduled uplink transmission on the primary serving cell. When described from the viewpoint of the base station, the base station, does not perform the scheduled uplink reception on the secondary serving cell in every subframe #4, but performs only the scheduled downlink transmission on the primary serving cell. In addition, the base station does not perform the scheduled downlink transmission on the secondary serving cell in every subframes #7 and #8, but performs only the scheduled uplink reception on the primary serving cell.

As described above, the muted serving cell is dependently determined according to a band to which the serving cell being the muting band or not. That is, the muted serving cell is band-specifically determined. The reason is that the TDD uplink/downlink configuration shown in Table 1 is band-specifically determined. That is, the same TDD uplink/downlink configuration is applied in the same band and the TDD uplink/downlink configuration is individually applied between different bands.

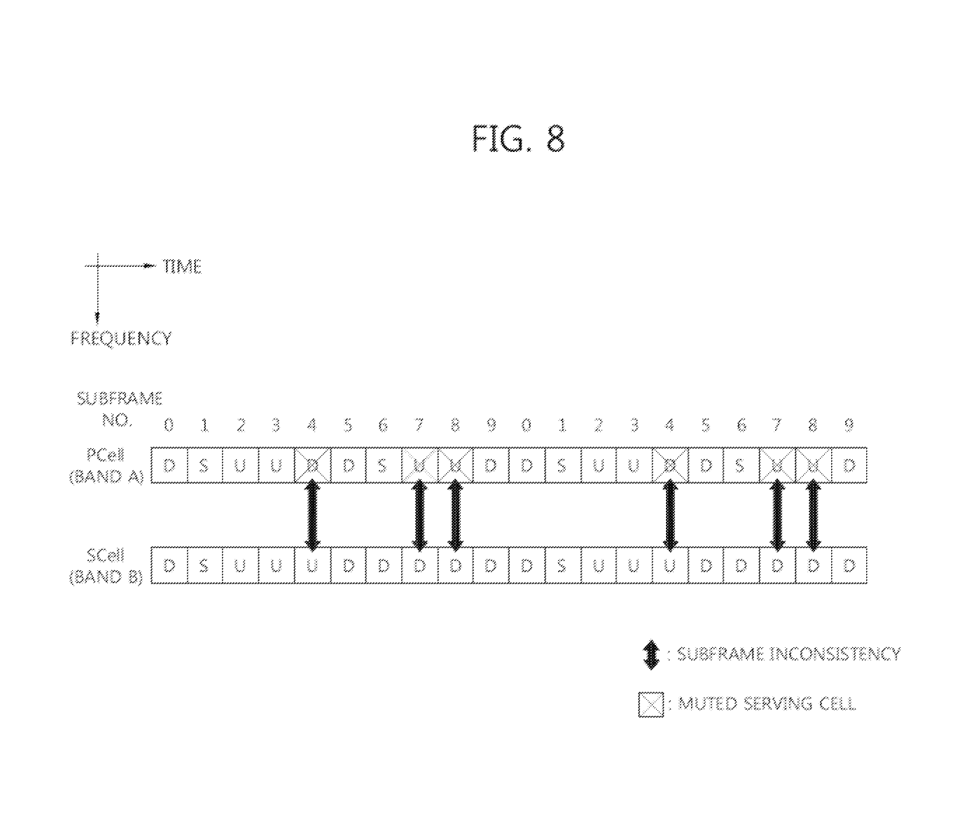

FIG. 8 is an explanatory diagram describing a muted serving cell selection rule according to another embodiment of the present invention.

Referring to FIG. 8, the band A is set as the muting band by the base station unlike FIG. 7. As a result, the user equipment does not perform the scheduled downlink reception on the primary serving cell in every subframe #4 (that is, mutes the primary serving cell), but performs only the scheduled uplink transmission on the secondary serving cell. In addition, the user equipment does not perform the scheduled uplink transmission on the primary serving cell in every subframes #7 and #8 (that is, mutes the primary serving cell), but performs only the scheduled uplink reception on the secondary serving cell. When described from the viewpoint of the base station, the base station does not perform the scheduled downlink transmission on the primary serving cell in every subframe #4, but performs only the scheduled uplink reception on the secondary serving cell. In addition, the base station does not perform the scheduled uplink reception on the secondary serving cell in every subframes #7 and #8, but performs only the scheduled downlink transmission on the secondary serving cell.

In FIGS. 7 and 8, a scenario in which only two serving cells are constituted in the user equipment is limitatively described. However, this is just exemplary and the band-specific muted serving cell selection rule may be similarly applied even in the case where three or more serving cells are constituted in the user equipment. For example, in the state in which two serving cells are constituted in the user equipment, one serving cell is additionally constituted. In this case, there may be a problem which serving cell to determine the muted serving cell based on. As one example, the user equipment may select the muted serving cell based on a newly added secondary serving cell. The muted serving cell which becomes a reference is referred to as a reference muted serving cell. As another example, the user equipment may select the reference muted serving cell according to muted serving cell information having a specific index. For example, the serving cell may be a serving cell having a lowest index. As another embodiment, the serving cell may be a secondary serving cell having a lowest index.

In the case where all of the TDD uplink/downlink configurations of respective serving cells are not the same as each other, at least one inconsistent subframe may be present in regard to three serving cells. In the case where three serving cells belong to different bands, when a band of the reference muted serving cell is set as the muting band, two remaining bands are set as the muting band when a subframe of the reference muted serving cell is a subframe in the same direction according to an uplink or a downlink and implicitly set as a non-muting band when the subframe of the reference muted serving cell is a subframe in a different direction. On the contrary, even when the band of the reference muted serving cell is set as the non-muting band, the bands are implicitly set according to the direction. As a result, transmission and reception directions between the serving cells in the inconsistent subframe are set as one. Therefore, the corresponding user equipment may operate on the inconsistent subframe in the half-duplex mode.

When the user equipment selects the muted serving cell or the effective serving cell based on the selection rule according the first embodiment, signaling of the base station is required. The base station transmits the RRC message (for example, Table 2) including the TDD information element of Table 3 or the system information block 1 (for example, Table 3) to the user equipment, and the TDD configuration information element of Table 4 includes the muted serving cell information.

TABLE 4

| | |
|---|---|
| -- ASN1START | |
| TDD-Config ::= | SEQUENCE { |

| | |
|---|---|
| subframeAssignment | ENUMERATED { |

sa0, sa1, sa2, sa3, sa4, sa5,

| | |
|---|---|
| sa6}, | |
| specialSubframePatterns | ENUMERATED { |

ssp0, ssp1, ssp2, ssp3, ssp4,ssp5, ssp6, ssp7, ssp8},

| | | |
|---|---|---|
| MutedSCellHalfDuplex | BOOLEAN | -- OPTIONAL, |

}
-- ASN1STOP

Referring to Table 4, the TDD configuration information element includes the muted serving cell information (MutedSCellHalfDuplex). The muted serving cell information is used to control a TDD configuration. However, the TDD configuration of the primary serving cell may be implicitly controlled according to a content of a field value.

The muted serving cell information may be handled by a user equipment which is a user equipment that supports the half-duplex mode or a user equipment that supports a full-duplex mode, but is operable in the half-duplex mode. The muted serving cell information sets the muted serving cell or the effective serving cell regarding the user equipment. The muted serving cell information is defined by a Boolean value. That is, the muted serving cell information indicates ‘true’ or ‘false’.

However, the muted serving cell information just divides only the muting band or the non-muting band as two states of ‘true’ or ‘false’ and does not include even information regarding which band being the muting band. A band in which each bit indicates muting or non-muting may be determined which message the TDD configuration information element is included in.

As one example, in the case where the RRC message shown in Table 2 is used to transmit the muted serving cell information, when the muted serving cell information ‘true’, the muted serving cell information of ‘true’ indicates that a band that belongs to a secondary serving cell changed or added by an RRC reconfiguration is the non-muting band. On the contrary, when the muted serving cell information is ‘false’, the muted serving cell information of ‘false’ indicates that the band that belongs to the secondary serving cell changed or added by the RRC reconfiguration is the muting band.

As another example, in the case where the system information block 1 shown in Table 3 is used to transmit the muted serving cell information, when the muted serving cell information is ‘true’, the muted serving cell information of ‘true’ indicates that a band belonging to the primary serving cell is the non-muting band. On the contrary, when the muted serving cell information is ‘false’, the muted serving cell information of ‘false’ indicates that the band belonging to the primary serving cell is the muting band.

When the muting band the non-muting band are divided, the serving cell is selected as the muted serving cell or the effective serving cell according to which band the serving cell belongs to. In other words, all serving cells belonging to the muting band are selected as the muted serving cell and all serving cells belonging to the non-muting band are selected as the effective serving cell. The reason is that the first embodiment follows the rule in which the muted serving cell is band-specifically selected. Whereas, a band belonging to another serving cell is classified as the muting band, and as a result, all of the serving cells belonging to the muting band are classified as the muted serving cells.

As described above, the user equipment may divide the muting band and the non-muting band may be divided based on the muted serving cell information and also divide the muted serving cell and the effective service cell. As a result, the user equipment abandons scheduled transmission and reception on the muted serving cell every inconsistent subframe and performs the scheduled transmission and reception on the effective serving cell.

### Second Embodiment

### Rule of Selecting Muted Serving Cell Specific to Transmission Link

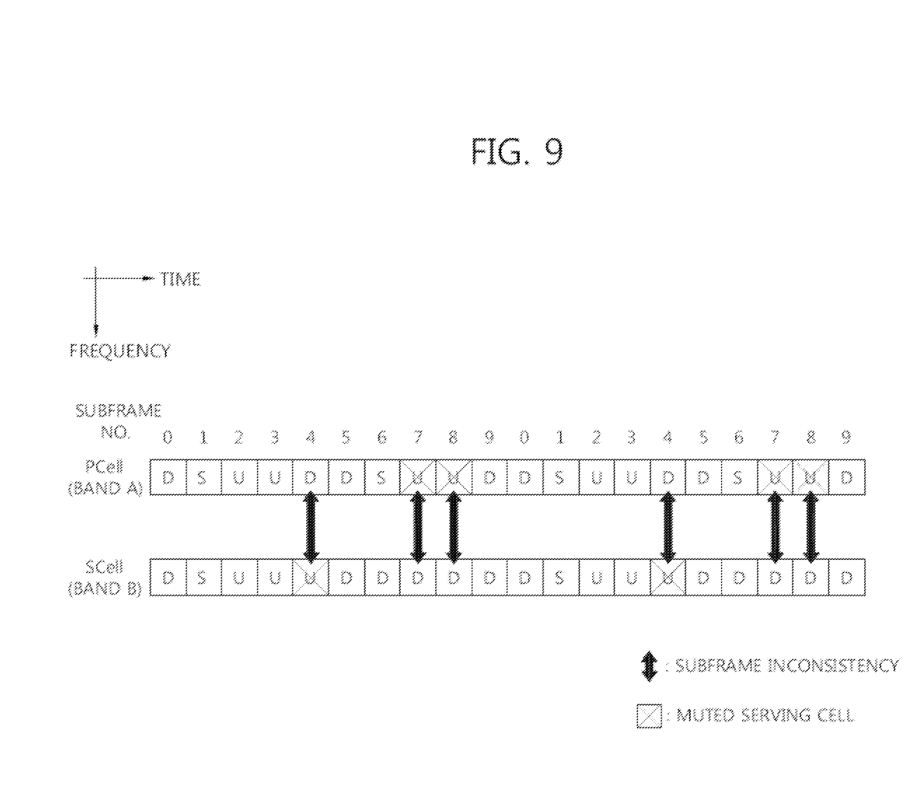

FIG. 9 is an explanatory diagram describing a muted serving cell selection rule according to yet another embodiment of the present invention.

Referring to FIG. 9, it is assumed that a primary serving cell (PCell) and a secondary serving cell (SCell) that belong to different bands A and B are configured by carrier aggregation, and the TDD uplink/downlink configuration 1 in Table 1 is applied to the primary serving cell and the TDD uplink/downlink configuration 3 in Table 1 is applied to the secondary serving cell. The inconsistent subframes are subframes #4, #7, and #8 of each radio frame.

The uplink is set as a muting link and the downlink is implicitly set as a non-muting link by the instruction of the base station. That is, in terms of allowance of the scheduled transmission and reception, the downlink takes precedence over the uplink.

The user equipment verifies whether a transmission link of which serving cell of the primary serving cell and the secondary serving cell is a muting link of which transmission and reception is disallowed, in the inconsistent subframe. Since every subframe #4 is the uplink subframe for the secondary serving cell, the transmission link corresponds to the muting link. Therefore, the user equipment selects the secondary serving cell as the muted serving cell in the subframe #4. On the contrary, since the subframe #4 is the downlink subframe, the transmission link corresponds to the non-muting link. Therefore, the user equipment selects the primary serving cell as the effective serving cell in the subframe #4.

Meanwhile, since the subframes #7 and #8 are the uplink subframes for the primary serving cell, the transmission link corresponds to the muting link. Therefore, the user equipment selects the primary serving cell as the muted serving cell in the subframes #7 and #8. On the contrary, since the subframes #7 and #8 are the downlink subframes for the secondary serving cell, the transmission link corresponds to the non-muting link. Therefore, the user equipment selects the secondary serving cell as the effective serving cell in the subframes #7 and #8.

As a result, only the uplink transmission is performed in the user equipment every inconsistent subframe and the serving cell of which the uplink transmission is performed may be different for each inconsistent subframe. The base station may determine a transmission preferred by the user equipment according to a traffic requirement amount of the user equipment.

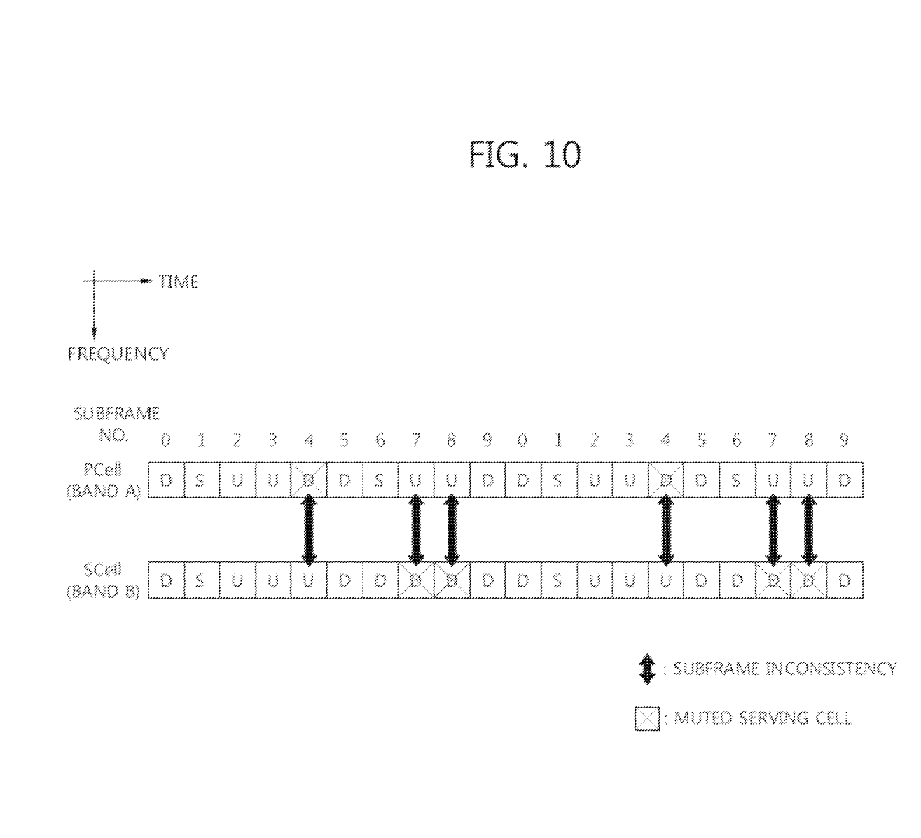

FIG. 10 is an explanatory diagram describing a muted serving cell selection rule according to yet another embodiment of the present invention.

Referring to FIG. 10, the downlink is set as the muting link by the instruction of the base station and the uplink is set implicitly set as the non-muting link unlike FIG. 9. The inconsistent subframes are every subframes #4, #7, and #8.

The user equipment verifies which serving cell of the primary serving cell and the secondary serving cell performs the scheduled transmission and reception through the muting link, in the inconsistent subframe. Since every subframe #4 is the downlink subframe for the primary serving cell, the transmission link corresponds to the muting link. Therefore, the user equipment selects the primary serving cell as the muted serving cell in the subframe #4. On the contrary, since every subframe #4 is the uplink subframe for the secondary serving cell, the transmission link corresponds to the non-muting link. Therefore, the user equipment selects the secondary serving cell as the effective serving cell in the subframe #4.

Meanwhile, since every subframes #7 and #8 are the downlink subframes for the secondary serving cell, the transmission link corresponds to the muting link. Therefore, the user equipment selects the secondary serving cell as the muted serving cell in the subframes #7 and #8. On the contrary, since every subframes #7 and #8 are the uplink subframes for the primary serving cell, the transmission link corresponds to the non-muting link. Therefore, the user equipment selects the primary serving cell as the effective serving cell in the subframes #7 and #8.

As a result, only the uplink transmission is performed in the user equipment every inconsistent subframe and the serving cell of which the uplink transmission is performed may be different for each inconsistent subframe. The base station may determine a transmission preferred by the user equipment according to a traffic requirement amount of the user equipment.

Signaling of the base station is required, which is required for the user equipment to select the muted serving cell or the effective serving cell based on the selection rule according the second embodiment. The base station transmits the RRC message (for example, Table 2) including the TDD information element of Table 4 or the system information block 1 (for example, Table 3) to the user equipment, and the TDD configuration information element of Table 5 includes the muted serving cell information.

TABLE 5

| | |
|---|---|
| -- ASN1START | |
| TDD-Config ::= | SEQUENCE { |

| | |
|---|---|
| subframeAssignment | ENUMERATED { |

| | sa0, sa1, sa2, sa3, sa4, sa5, sa6}, |
|---|---|
| specialSubframePatterns | ENUMERATED { |
| | ssp0, ssp1, ssp2, ssp3, ssp4,ssp5, ssp6, ssp7, ssp8}, |

| | | |
|---|---|---|
| MutedSCellHalfDuplex | BOOLEAN | -- OPTIONAL, |

}
-- ASN1STOP
}

Referring to Table 5, the TDD configuration information element includes the muted serving cell information (MutedSCellHalfDuplex). The muted serving cell information is used to control a TDD configuration. However, the TDD configuration of the primary serving cell may be implicitly controlled according to a content of a field value.

The muted serving cell information may be handled by a user equipment which is a user equipment that supports the half-duplex mode or a user equipment that supports a full-duplex mode, but is operable in the half-duplex mode. The muted serving cell information sets the muted serving cell or the effective serving cell regarding the user equipment. The muted serving cell information is defined by a Boolean value. That is, the muted serving cell information indicates ‘true’ or ‘false’.

For example, when the muted serving cell information shown in Table 23 is ‘true’, the muted serving cell information of ‘true’ indicates that the downlink is set as the muting link. As a result, the uplink is implicitly set as the non-muting link. On the contrary, when the muted serving cell information is ‘true’, the muted serving cell information of ‘false’indicates that the uplink is set as the muting link. As a result, the downlink is implicitly set as the non-muting link.

Therefore, all serving cells that the scheduled transmission and reception through the non-muting link every inconsistent subframe are classified as the muted serving cells. The reason is that the first embodiment follows the rule in which the muted serving cell is link-specifically selected. Meanwhile, a band belonging to another serving cell is classified as the muting band, and as a result, all of the serving cells belonging to the muting band are classified as the muted serving cells.

The user equipment verifies which serving cell of the primary serving cell and the secondary serving cell performs the scheduled transmission and reception through the muting link, in the inconsistent subframe. In addition, the serving cell corresponding to the muting link is selected as the muted serving cell. On the contrary, the user equipment selects as the effective serving cell the serving cell corresponding to the non-muting link to perform the scheduled transmission and reception only in the effective serving cell.

Meanwhile, when the base station intends to change the muting link, an RRC message of a different type from that of Table 2 may be used as a used message.

### Third Embodiment

### Rule of Directly Selecting Muted Serving Cell Based on Bitmap

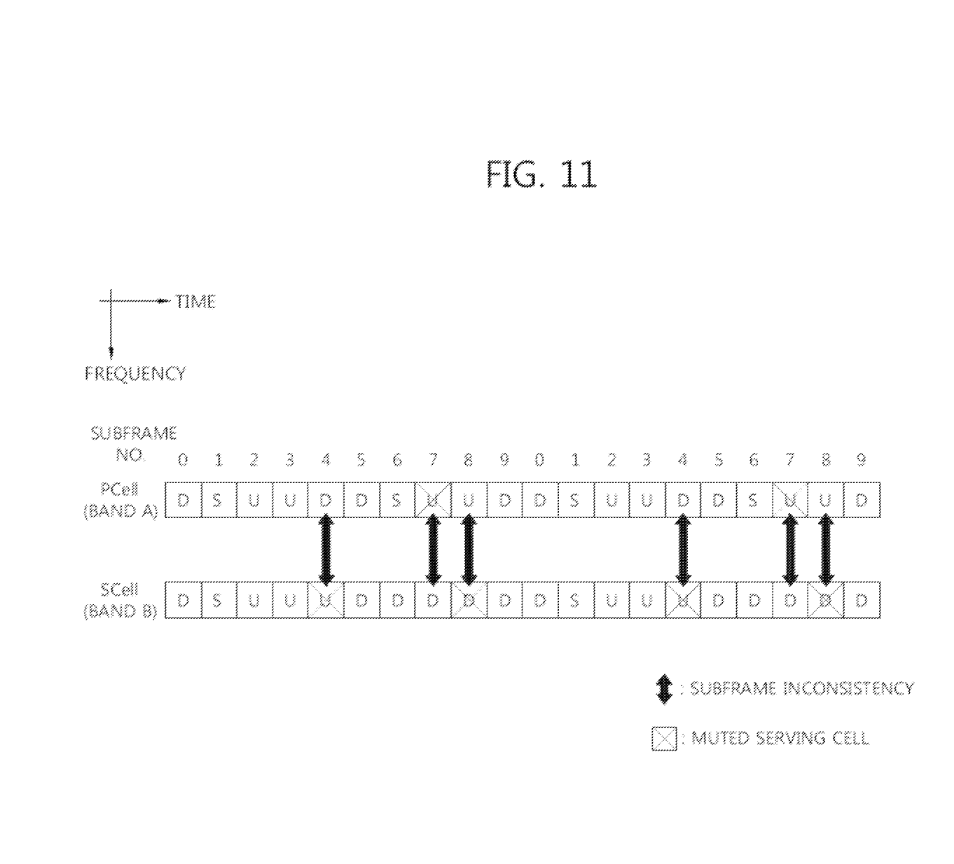

FIG. 11 is an explanatory diagram describing a muted serving cell selection rule according to yet another embodiment of the present invention.

Referring to FIG. 11, it is assumed that a primary serving cell (PCell) and a secondary serving cell (SCell) that belong to different bands A and B are configured by carrier aggregation, and the TDD uplink/downlink configuration 1 in Table 1 is applied to the primary serving cell and the TDD uplink/downlink configuration 3 in Table 1 is applied to the secondary serving cell. The inconsistent subframes are subframes #4, #7, and #8 of each radio frame.

The base station sets the band B as the muting band in the subframe #4, sets the band A as the muting band in the subframe #7, and sets the band B as the muting band in the subframe #8 again. In addition, the base station transmits the RRC message (for example, Table 2) including the TDD configuration information element or the system information block 1 (for example, Table 3) so that the user equipment selects the muted serving cell based on the set muting band. As one example, the TDD configuration information element may be defined as shown in Table 6.

TABLE 6

| | |
|---|---|
| -- ASN1START | |
| TDD-Config ::= | SEQUENCE { |

| | |
|---|---|
| subframeAssignment | ENUMERATED { |

| | |
|---|---|
| | sa0, sa1, sa2, sa3, sa4, sa5, sa6}, |
| specialSubframePatterns | ENUMERATED { |
| | ssp0, ssp1, ssp2, ssp3, ssp4,ssp5, ssp6, ssp7, ssp8}, |

| | |
|---|---|
| MutedSCellHalfDuplex | BITSTRING(SIZE (10)) -- ‘0000000100’ (subframe |
| 0, 1, 2, 3, 4, 5, 6, 7, 8, 9) | |

}
-- ASN1STOP

Referring to Table 6, the TDD configuration information element includes the muted serving cell information (MutedSCellHalfDuplex). The muted serving cell information may be defined as the bitmap. Herein, the bitmap includes bits as many as the subframes in the radio frame. For example, since the radio frame includes ten subframes, the length of the bitmap is 10 bits. In addition, the bits of the bitmap correspond to ten subframes one to one. For example, when the bitmap is ‘abcdefghij’, a, b, c, d, e, f, g, h, i, and j correspond to, subframes #0, #1, #2, #3, #4, #5, #6, #7, #8, and #9, respectively.

Each bit indicates the muting band in the corresponding subframe. The bitmap corresponds to even the consistent subframe as well as the inconsistent subframe. Bits corresponding to the inconsistent subframe indicate the muting band or the non-muting band. Each bit just divides only the muting band or the non-muting band as 0 or 1 and does not include even information regarding which band is the muting band. A band in which each bit indicates muting or non-muting may be determined which message the TDD configuration information element is included in.

As one example, in the case where the RRC message shown in Table 2 is used to transmit the muted serving cell information, when a value of the bit corresponding to the inconsistent subframe is 1, the bit value indicates that the band that belongs to the secondary serving cell changed or added by the RRC reconfiguration is the non-muting band. On the contrary, when the value of the bit corresponding to the inconsistent subframe is 0, the bit value indicates that the band that belongs to the secondary serving cell changed or added by the RRC reconfiguration is the muting band.

As another example, in the case where the system information block 1 shown in Table 3 is used to transmit the muted serving cell information, when the value of the bit corresponding to the inconsistent subframe is 1, the bit value indicates that the band that belongs to the primary serving cell is the non-muting band. On the contrary, when the value of the bit corresponding to the inconsistent subframe is 0, the bit value indicates that the band that belongs to the primary serving cell is the muting band.

In the case of FIG. 11, since the secondary serving cell is added by the RRC reconfiguration, the band B including the secondary serving cell may be classified as the muting band or the non-muting band according to the bit value.

Herein, the bits corresponding to the consistent subframe may have even any value. The reason is that all serving cells in the consistent subframe have the same transmission link, the muted serving cell is not present. In the example, all of the bits corresponding to the consistent subframe are set to 0, but this is just exemplary and the bits may have even any value.

From the viewpoint of the user equipment, the user equipment may verify the muting band for each inconsistent subframe defined by the base station based on the muted serving cell information. In the case where the bitmap is ‘0000000100’, both the bit values corresponding to the inconsistent subframes #4 and #8 are 0, the band B is the muting band. Therefore, the user equipment selects the secondary serving cells that belong to the band B as the muting band and selects the primary serving cells that belong to the non-multign band in the subframes #4 and #8. Meanwhile, in the subframe #7 as the inconsistent subframe, since the bit value is 1, the band A is the muting band. Therefore, the user equipment selects the primary serving cell as the muted serving cell in the subframe #7 and selects the secondary serving cell as the effective serving cell.

As another example, the TDD configuration information element may be defined as shown in Table 7.

TABLE 7

| | |
|---|---|
| -- ASN1START | |
| TDD-Config ::= | SEQUENCE { |

| | |
|---|---|
| subframeAssignment | ENUMERATED { |

| | |
|---|---|
| | sa0, sa1, sa2, sa3, sa4, sa5, sa6}, |
| specialSubframePatterns | ENUMERATED { |

ssp0, ssp1, ssp2, ssp3, ssp4,ssp5, ssp6, ssp7, ssp8},

| | |
|---|---|
| MutedSCellHalfDuplex | BITSTRING(SIZE (5)) -- ‘01010’ (subframes #4, |

#7, and #8 among subframes #3,# 4, #7, #8, and #9 are the inconsistent subframes)

}
-- ASN1STOP

Referring to Table 7, the TDD configuration information element includes the muted serving cell information (MutedSCellHalfDuplex). The muted serving cell information may be defined as the bitmap. Herein, the bitmap includes bits as many as all latent inconsistent subframes in terms of the TDD uplink/downlink configuration in the radio frame. Herein, all latent inconsistent subframes represent all subframes that may become the inconsistent subframes in the TDD uplink/downlink configuration. For example, assumed that all available inconsistent subframes in all TDD uplink/downlink configurations are the subframes #3, #4, #7, #8, and #9, since the number of the latent inconsistent subframes is 5, the length of the bitmap is 5 bits. In addition, the bits of the bitmap correspond to five latent inconsistent subframes one to one. For example, when the bitmap is ‘abcde’, a, b, c, d, and e correspond to the subframes #3, #4, #7, #8, and #9, respectively.

Each bit indicates the muting band in the corresponding inconsistent subframe.

As one example, in the case where the RRC message shown in Table 2 is used to transmit the muted serving cell information, when the value of the bit corresponding to the inconsistent subframe is 1, the bit value indicates that the band that belongs to the secondary serving cell changed or added by the RRC reconfiguration is the non-muting band. On the contrary, when the value of the bit corresponding to the inconsistent subframe is 0, the bit value indicates that the band that belongs to the secondary serving cell changed or added by the RRC reconfiguration is the non-muting band indicates that the band that belongs to the secondary serving cell changed or added by the RRC reconfiguration is the muting band.

As another example, in the case where the system information block 1 shown in Table 3 is used to transmit the muted serving cell information, when the value of the bit corresponding to the inconsistent subframe is 1, the bit value indicates that the band that belongs to the primary serving cell in the corresponding inconsistent subframe is the non-muting band. On the contrary, when the value of the bit corresponding to the inconsistent subframe is 0, the bit value indicates that the band that belongs to the primary serving cell in the corresponding inconsistent subframe is the muting band.

From the viewpoint of the user equipment, the user equipment may verify the muting band for each inconsistent subframe defined by the base station based on the muted serving cell information. In the case where the bitmap is ‘00100’, only a bit corresponding to an actual inconsistent subframe includes significant information in terms of the TDD uplink/downlink configuration. For example, assumed that subframes #4, #7, and #8 among five latent inconsistent subframes are the actual inconsistent subframes, the values of the bits corresponding to the subframes #3 and #9 are 0, but have no particular meaning. Meanwhile, since both the bit values corresponding to the actual inconsistent subframes #4 and #8 are 0, the band B is the muting band. Therefore, the user equipment selects the secondary serving cells that belong to the band B as the muting band and selects the primary serving cells that belong to the non-multign band in the subframes #4 and #8. Meanwhile, in the subframe #7 as the actual inconsistent subframe, since the bit value is 1, the band A is the muting band. Therefore, the user equipment selects the primary serving cell as the muted serving cell in the subframe #7 and selects the secondary serving cell as the effective serving cell.

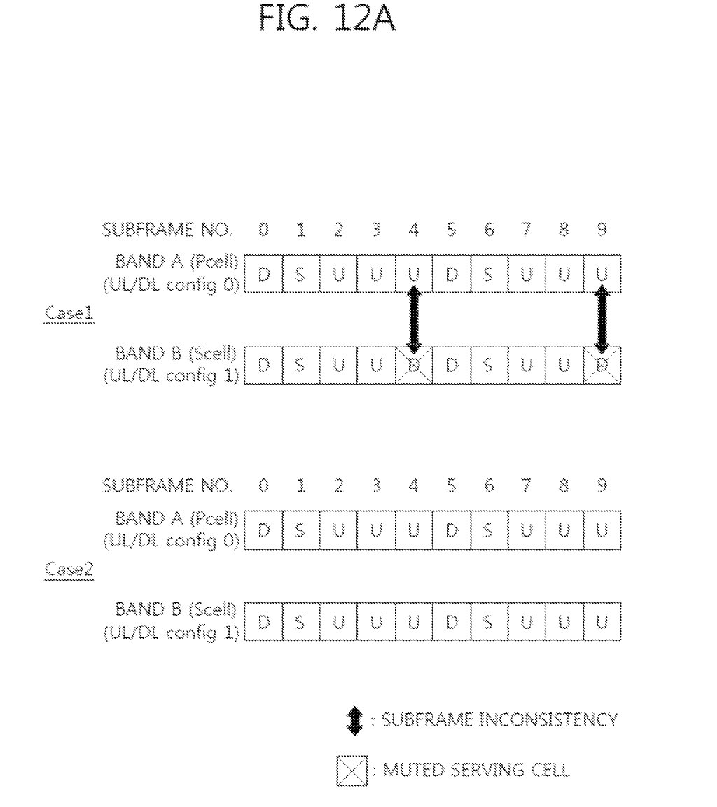

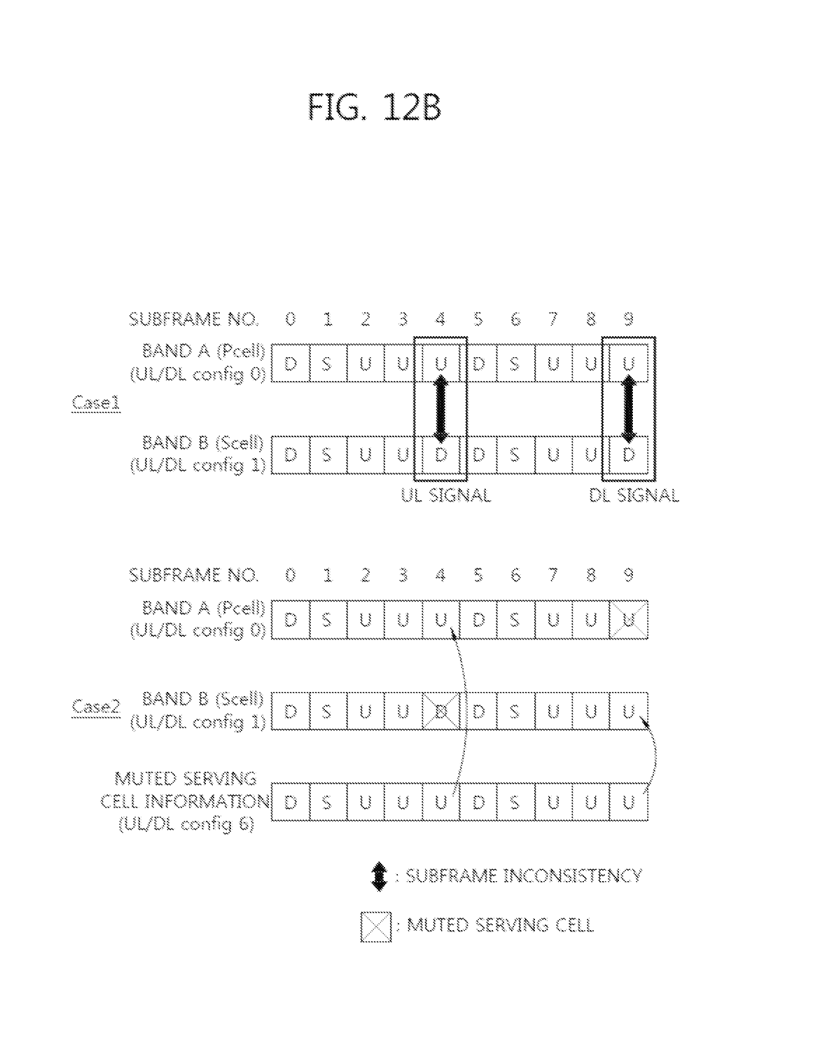

FIG. 12A is an explanatory diagram describing a method for controlling a TDD uplink/downlink configuration of a band according to one example.

Referring to FIG. 12A, in Case 1, TDD uplink/downlink configuration (UL/DL config) #0 is applied to the band A including the primary serving cell and uplink/downlink configuration (UL/DL config) #1 is applied to the band B including the second serving cell. In this state, since the band B is the muting band, when the secondary serving cell is selected as the muted serving cell, the user equipment may perform only the scheduled uplink transmission on the primary serving cell in the subframes #4 and 9# as the inconsistent subframes and may not perform the scheduled downlink reception on the secondary serving cell. In this case, resources of the secondary serving cell are wasted. That is, when the half-duplex mode is followed, only any one serving cell unavoidably survives in the inconsistent subframe to perform the scheduled transmission and reception and the scheduled transmission and reception in the remaining serving cells are abandoned. A generation cause of the inconsistent subframe is that different TDD uplink/downlink configurations are applied to the bands.

In this case, when the TDD uplink/downlink configuration of the muting band is made to be the same as the TDD uplink/downlink configuration of the non-muting band like Case 2, the resources wasted on the secondary serving cell is reduced and the inconsistent subframe is removed to concentrate the resources on the uplink transmission. Accordingly, the subframes #4 and #9 which are the inconsistent subframes in Case 1 are not the inconsistent subframes any longer and the subframes #4 and #9 are configured as the uplink subframes in both the primary serving cell and the secondary serving cell.

Contrary to this, the TDD uplink/downlink configuration of the band A may be changed similarly as the TDD uplink/downlink configuration #0 of the band B. In this case, the subframes #4 and #9 become the downlink subframes in both the primary serving cell and the secondary serving cell.

In order to make the TDD uplink/downlink configurations of other bands to be the same as each other, the base station may transmit to the user equipment the RRC message that gets the TDD uplink/downlink configuration applied to the priority band A to be applied to the band B. Alternatively, the base station may transmit the RRC message to the user equipment so that the same TDD uplink/downlink configuration is applied to the bands A and B from the beginning.

FIG. 12B is an explanatory diagram describing a method for controlling a TDD uplink/downlink configuration of a band according to another example.

Referring to FIG. 12B, in Case 1, TDD uplink/downlink configuration #0 is applied to the band A including the primary serving cell and uplink/downlink configuration #1 is applied to the band B including the second serving cell. The inconsistent subframes are the subframes #4 and #9. Herein, the base station may transmit to the user equipment the muted serving cell information used to select a direction of the transmission link in each inconsistent subframe by considering preference of the user equipment. The muted serving cell information indicates a TDD uplink/downlink configuration in which a link of a specific subframe is set in a direction preferred by the user equipment. Herein, the specific subframe may mean a subframe corresponding to No. of a current inconsistent subframe. A TDD uplink/downlink configuration in this case may be named as an effective TDD uplink/downlink configuration.

As one example, the muted serving cell information is included in the RRC message.

As another example, the muted serving cell information is included a DCI of a new format. The new-format DCI is information which may be recognized by a user equipment in the half-duplex mode that supports dynamic adaptation. Since the new-format DCI is transmitted to the user equipment with being mapped to a PDCCH, a dynamic muted serving cell may be set. The new-format DCI may allocate n bits to represent the muted serving cell information. For example, when n=3, the muted serving cell information as 3 bits may indicate 2³ (=8) effective TDD uplink/downlink configurations.

For example, assumed that the user equipment prefers the uplink transmission in the subframe #4 and the downlink reception in the subframe #9, one TDD uplink/downlink configuration that reflects the preference of the user equipment is DSUUUDSUUD and TDD uplink/downlink configuration is the same as the TDD uplink/downlink configuration #6 in Table 1. According to the TDD uplink/downlink configuration #6, the subframe #4 is the uplink subframe and the subframe #49 is the downlink subframe.

When the user equipment receives the muted serving cell information, the user equipment extracts the subframes #4 and #9 corresponding to the inconsistent subframes in the TDD uplink/downlink configuration #6 and determines a link direction in each extracted subframe as the non-muting link. For example, since the subframe #4 is the uplink subframe in which a link direction of the muted serving cell information signaled to the RRC is an uplink direction, the uplink becomes the non-muting link in the inconsistent subframe #4. Meanwhile, since the subframe #9 is the downlink subframe in which the link direction of the muted serving cell information signaled to the RRC is a downlink direction, the downlink becomes the non-muting link in the inconsistent subframe #9.

In this case, since the uplink is the non-muting link in the subframe #4 as the existing inconsistent subframe like Case 2, the user equipment selects the primary serving cell in which the subframe #4 is the uplink as the effective serving cell. On the contrary, the user equipment selects the secondary serving cell in which the subframe #4 is the downlink as the muted serving cell. Meanwhile, since the downlink is the non-muting link in the subframe #9 which is the existing inconsistent subframe, the user equipment selects the secondary serving cell in which the subframe #9 is the downlink as the effective serving cell. On the contrary, the user equipment selects the primary serving cell in which the subframe #9 is the uplink as the muted serving cell.

According to the present invention, when the muted serving cell is selected, the scheduled transmission and reception are not performed any longer in the muted serving cell. Accordingly, a point when the scheduled transmission and reception are stopped in the muted serving cell should be clearly stipulated. Hereinafter, a muting start point will be disclosed in detail.

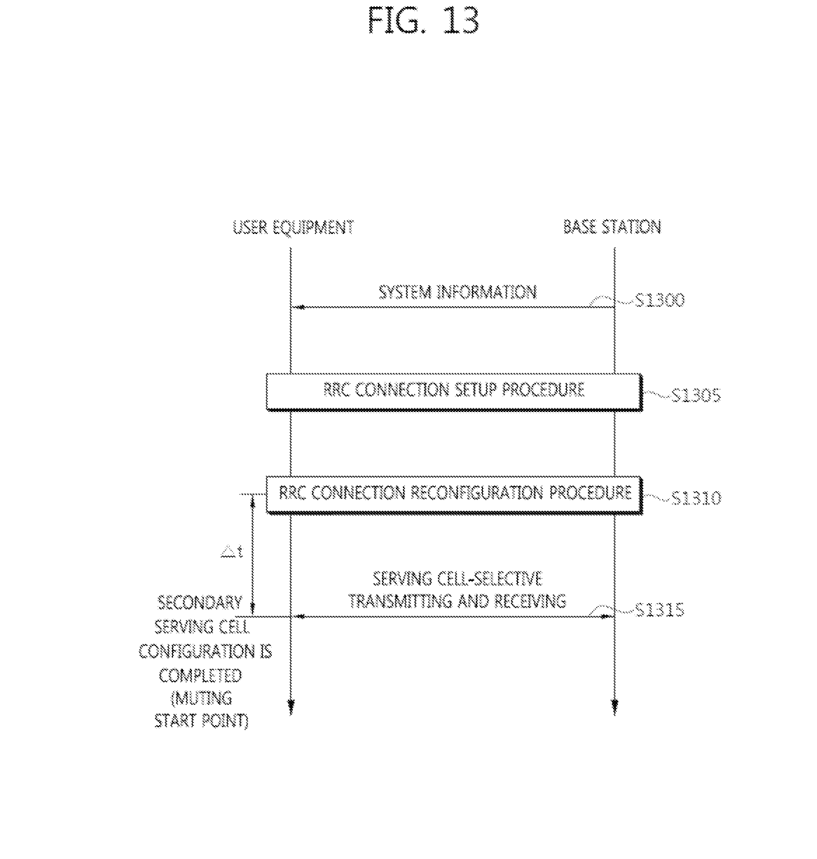

As one example, the muting start point may be a time when configuring the second serving in the user equipment is completed. FIG. 13 is an operational flowchart for describing a muting start point according to one example of the present invention.

Referring to FIG. 13, the user equipment receives system information transmitted from the base station through a cell search procedure (S1300).

The user equipment performs an RRC connection setup procedure with the base station based on the system information (S1305). The user equipment transmits an RRC connection request message to the base station, the base station transmits an RRC connection setup to the user equipment, and the user equipment transmits an RRC connection setup completion message to the base station to perform the RRC connection setup procedure. The RRC connection setup procedure includes a setup of SIB1. In the case where only the primary serving cell is constituted in the user equipment, that is, in the case where the user equipment operates by a single carrier, the user equipment is not in a carrier aggregation state, and as a result, a TDD configuration information element is not used.

The user equipment additionally configures a secondary serving cell other than a band to which the primary serving cell as necessary or performs an RRC connection reconfiguration procedure of changing a setup of a secondary serving cell which has been already configured together with the base station (S1310). The base station transmits the RRC connection reconfiguration message to the user equipment and the user equipment transmits the RRC connection reconfiguration completion message to the base station to perform the RRC connection reconfiguration procedure. The RRC message used in the RRC connection reconfiguration procedure of step S1310 may include, for example, the TDD configuration information element in Table 2. As a result, carrier aggregation is achieved between the primary serving cell and the secondary serving cell, and since the primary serving cell and the secondary serving cell belong to different bands, the TDD uplink/downlink configurations applied to the primary and secondary serving cells may be different from each other. Due to such a difference, the inconsistent subframe is generated and the user equipment reads muted serving cell information of the TDD configuration information element and selects the muted serving cell in the inconsistent subframe (not illustrated).

The RRC connection reconfiguration procedure of the user equipment is completed until Δt has elapsed from a point when the user equipment receives the RRC connection reconfiguration message from the base station and this point becomes the muting start point. Accordingly, from this point, the user equipment performs serving cell selective signal transmission and reception (S1315). That is, the user equipment does not perform scheduled transmission and reception on the muted serving cell selected every inconsistent subframe, but performs only the scheduled transmission and reception on only the effective serving cell.

As another example, the muting start point may be a time when the second serving cell constituted in the user equipment is activated.

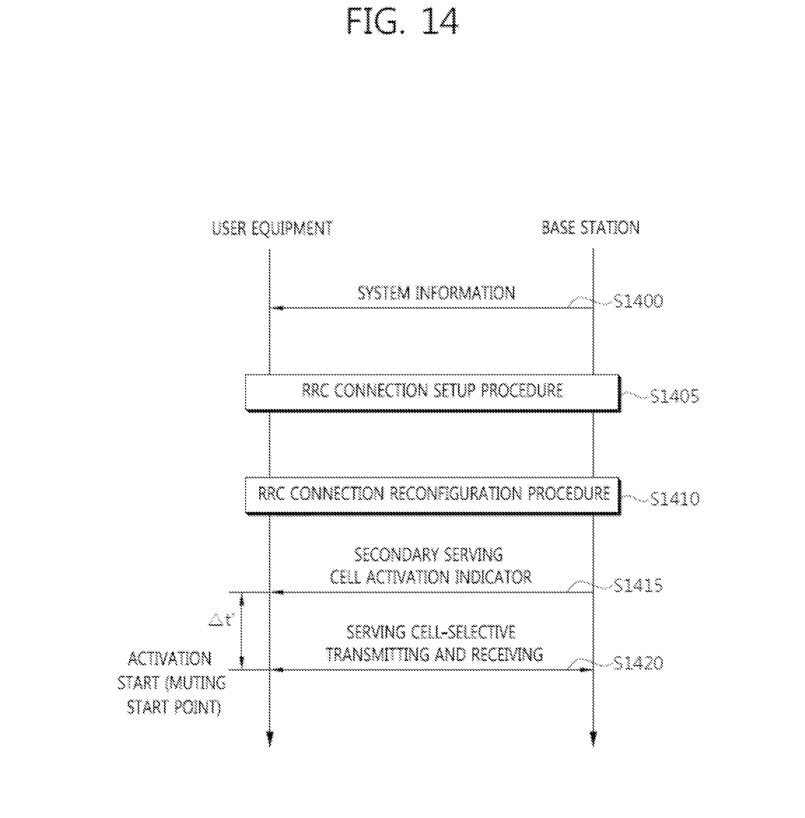

FIG. 14 is an operational flowchart for describing the muting start point according to another example of the present invention.

Referring to FIG. 14, the user equipment receives the system information transmitted from the base station through the cell search procedure (S1400).

The user equipment performs the RRC connection setup procedure with the base station based on the system information (S1405). The user equipment transmits the RRC connection request message to the base station, the base station transmits the RRC connection setup to the user equipment, and the user equipment transmits the RRC connection setup completion message to the base station to perform the RRC connection setup procedure. The RRC connection setup procedure includes the setup of SIB1. In the case where only the primary serving cell is constituted in the user equipment, that is, in the case where the user equipment operates by the single carrier, the user equipment is not in the carrier aggregation state, and as a result, the TDD configuration information element is not used.

The user equipment additionally configures the secondary serving cell other than the band to which the primary serving cell as necessary or performs the RRC connection reconfiguration procedure of changing the setup of the secondary serving cell which has been already configured together with the base station (S1410). The base station transmits the RRC connection reconfiguration message to the user equipment and the user equipment transmits the RRC connection reconfiguration completion message to the base station to perform the RRC connection reconfiguration procedure. The RRC message used in the RRC connection reconfiguration procedure of step S1410 may include, for example, the TDD configuration information element in Table 2. As a result, the carrier aggregation is achieved between the primary serving cell and the secondary serving cell, and since the primary serving cell and the secondary serving cell belong to different bands, the TDD uplink/downlink configurations applied to the primary and secondary serving cells may be different from each other. Due to such a difference, the inconsistent subframe is generated and the user equipment reads muted serving cell information of the TDD configuration information element and selects the muted serving cell in the inconsistent subframe (not illustrated).

When the RRC connection reconfiguration procedure of the user equipment is completed, the base station transmits to the user equipment an activation indicator of command activation of the secondary serving cell additionally constituted in the user equipment (S1415). When the secondary serving cell is inactivated although the secondary serving cell is constituted in the user equipment, effective data is not transmitted and received, and as a result, when traffic is increased, the base station may indicate the activation of the secondary serving cell.

Although the secondary serving cell activation indicator is received, point when the secondary serving cell is substantially activated with a predetermined time Δt′ elapsed after the subframe in which the activation indicator is received. Δt′ may be, for example, four subframes (alternatively, 4 ms).

The point when the activation of the secondary serving cell becomes the muting start point. Accordingly, from this point, the user equipment performs the serving cell selective signal transmission and reception (S1420). That is, the user equipment does not perform the scheduled transmission and reception on the muted serving cell selected every inconsistent subframe, but performs only the scheduled transmission and reception on only the effective serving cell.

As described above, according to the present invention, when inter-band carrier aggregation is achieved in a TDD system, the user equipment and the base station may implement a stable operation even on the inconsistent subframe by using the muted serving cell information and the muted serving cell selection rule.

### Fourth Embodiment

### Rule of Selecting Dynamic Muted Serving Cell

In the first to third embodiments, since the base station transmits the muted serving cell information through the RRC message or the system information block, the base station needs to transmit a new RRC message or system information block including new muted serving cell information in order to change the muted serving cell (alternatively, the TDD uplink/downlink configuration). However, updating of the muted serving cell information by higher layer signaling takes a longer time than that by lower layer signaling.

Accordingly, in the fourth embodiment, a method in which the muted serving cell may be dynamically selected is presented. The base station may discriminate an effective serving cell having a TDD uplink/downlink configuration suitable for the user equipment in the inconsistent subframe according to a traffic environment and a muted serving cell having no TDD uplink/downlink configuration, based on a scheduling request (SR) transmitted from the user equipment and a buffer state report (BSR) in a PUSCH, and dynamically notify the muted serving cell information by using the PDCCH. Such a dynamic muted serving cell selection rule is characterized in that the muted serving cell is achieved by dynamic signaling such as the PDCCH. The muted serving cell information is included in new-format downlink control information (DCI) and the DCI is mapped to the PDCCH which is the physical channel.

However, since the muted serving cell information is transmitted by the dynamic signaling, if the user equipment may not know a subframe in which the muted serving cell information is transmitted, the user equipment has a burden of acquiring the muted serving cell information by blind-decoding the PDCCH every subframe. However, this may be an unnecessary operation, HARQ buffer corruption may occur through missing of the PDCCH, and indefiniteness of the downlink subframe for measuring channel state information (CSI) may occur. For example, since whether to monitor a downlink channel for a specific serving cell in the inconsistent subframe may be determined according to transmission of an uplink channel for another serving cell, for example, the PUSCH, the operation may cause the indefiniteness of the system.

Accordingly, in order to more stably perform a muted serving cell selecting operation in a in more stable inconsistent subframe, the muted serving cell information is preferably transmitted in a subframe which may be predicted by the user equipment. In addition, when the muted serving cell is selected by using the muted serving cell information received in the subframe at the prediction point by the user equipment, an actual muting start point needs to be definitely stipulated.

First, the subframe in which the muted serving cell information is transmitted will be disclosed.

Since the muted serving cell information is information which the base station transmits to the user equipment, the muted serving cell information needs to be transmitted through the downlink subframe. Referring to Table 1 as an example, all TDD uplink/downlink configurations have the subframes #0, #1, #5, and #6 as the downlink subframes. At least four subframes are not the inconsistent subframe and the muted serving cell is not also generated. Accordingly, when the muted serving cell information is transmitted in the four subframes, a situation does not occur, in which the user equipment is disabled to receive the muted serving cell information.

However, in order to prevent inefficient blind decoding, the base station notifies, to the user equipment, which subframe of the four subframes the muted serving cell information is transmitted through, as a subframe indicator in advance. The subframe indicator may be included in higher layer signaling which the base station transmits to the user equipment, for example, the RRC message. The subframe indicator may indicate any one subframe of the subframes #0, #1, #5, and #6 as 2 bits. Alternatively, the subframe indicator may have a cycle and an offset. Alternatively, the subframe indicator may indicate at least one subframe in a bitmap format every radio frame.

The subframe indicator may be updated. However, the muted serving cell information is transmitted in only a subframe indicated by the existing subframe indicator until the updated subframe indicator is newly transmitted. For example, the subframe indicator indicates the subframe #0 in frame #10, however, a new subframe indicator that indicates the subframe #6 may be transmitted from frame #50. In this case, the muted serving cell information is transmitted in the subframe #0 from frames #10 to #49 and thereafter, the muted serving cell information is transmitted in the subframe #6 from the frame #50. Meanwhile, in the state where the secondary serving cell is added to the user equipment by the RRC connection reconfiguration and the user equipment is disabled to receive the subframe indictor, it may be, in advance, designated that the muted serving cell information is transmitted in any one of the four subframes by default setting.

Herein, a candidate group of subframes in which the muted serving cell information is transmitted is described as the subframes #0, #1, #5, and #6, but the candidate group is not limited to only the subframes #0, #1, #5, and #6 and the RRC may be set so that transmission is possible even in other subframes.

The muted serving cell information is defined in the new-format DCI as described above and the new-format DCI is mapped to the PDCCH of the downlink subframe indicated by the subframe indicator. In this case, the muted serving cell information may be 1 bit. The DCI including the muted serving cell information may be represented in a table shown below.

TABLE 8
Carrier indicator: 0 or 3 bits
HARQ process No.: 3 bits (FDD), 4 bits (TDD)
Transmission power control command for PUCCHC: 2 bits
Downlink assignment index): 2 bits
For each transmission block
Modulating and coding schemes: 5 bits
New data indicator: 1 bit
Redundancy version: 2 bits
Local/distributive VRB allocation flag: 1 bit
Resource block allocation
Local resource allocation: [ log₂(N_{RB}^{DL}(N_{RB}^{DL} + 1)/2 ] bit
Distribution resource allocation: [ log₂(N_{RB}^{DL}(N_{RB}^{DL} + 1)/2 ] or
[ log₂(N_{RB}^{DL}(N_{RB}^{DL} + 1)/2 − 1 ]
bit
Muted serving cell information: 1 bit

Referring to Table 8, the new-format DCI includes various fields and in particular, includes 1-bit muted serving cell information and the new-format DCI is indicated by the muted serving cell information as follows.

As one example, when the muted serving cell information is 0, the muted serving cell information means that the existing muted serving cell is continuously maintained. On the contrary, when the muted serving cell information is 1, the muted serving cell information may mean that the muted serving cell is changed (alternatively, toggled) in a radio frame next to a radio frame in which an HARQ process for the PDCCH where the muted serving cell information is transmitted is ended.

As another example, when the muted serving cell information is 0, the muted serving cell information indicates that a band at which the primary serving cell is positioned is the non-muting band. On the contrary, when the muted serving cell information is 1, the muted serving cell information indicates that the band at which the primary serving cell is positioned is the muting band (based on the first embodiment).

As yet another example, when the muted serving cell information is 0, the muted serving cell information indicates that the uplink is the muting link. On the contrary, when the muted serving cell information is 1, the muted serving cell information indicates that the downlink indicates the muting link (based on the second embodiment).

The muted serving cell information may be transmitted on the primary serving cell or the secondary serving cell additionally constituted in the user equipment. When the muted serving cell information is n bits, blind-decoding the PDCCH is performed assumed that a new-format DCI added with n bits is transmitted in the downlink subframe indicated by the subframe indicator. As a result, the number of blind-decoding times is decreased and furthermore, since the new-format DCI is transmitted in only the subframe indicated by the subframe indicator, the size of the DCI may not uniformly increased with respect to all subframes. Accordingly, reception reliability of the PDCCH may be increased.

Next, in the muted serving cell dynamically selected according to the muted serving cell information, the muting start point when the scheduled transmission and reception are stopped will be described. Meanwhile, the muting start point may be defined as a point when the user equipment receives the updated muted serving cell information and thereafter, substantially applies the received muted serving cell information.

As one example, a subframe in which the user equipment transmits an ACK signal for a downlink grant or an uplink grant to the base station and it is recognized that the base station is ACK becomes the muting start point. That is, a time when it is verified that the PDCCH transmitted by the base station is successfully transmitted to the user equipment becomes the muting start point.

As another example, a radio frame next to the radio frame to which the subframe in which the HARQ process indicated by the PDCCH including the muted serving cell information is completed becomes the muting start point.

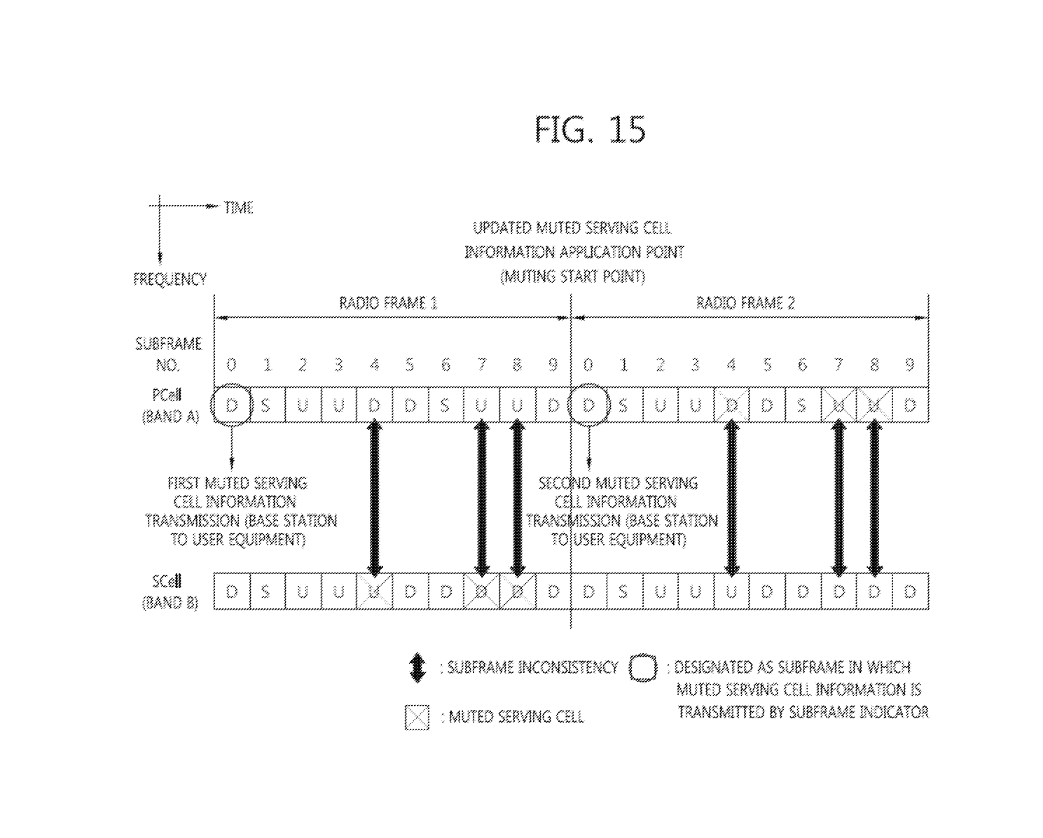

FIG. 15 is an explanatory diagram describing a muted serving cell selection rule according to yet another example of the present invention. This is a rule of selecting the muted serving cell by a scheme of mixing the first embodiment and the fourth embodiment. That is, whenever the muted serving cell information is dynamically changed, the muted serving cell is band-specifically changed.

Referring to FIG. 15, it is assumed that a primary serving cell (PCell) and a secondary serving cell (SCell) that belong to different bands A and B are configured by carrier aggregation, and the TDD uplink/downlink configuration 1 in Table 1 is applied to the primary serving cell and the TDD uplink/downlink configuration 3 in Table 1 is applied to the secondary serving cell. The inconsistent subframes are subframes #4, #7, and #8 of each radio frame. In addition, the subframe in which the muted serving cell information is transmitted is designated as every subframe #0 by the subframe indicator.

Radio frame 1 is in the state where the base station sets the band B as the muting band. Therefore, in the subframes #4, #7, and #8 that belong to the radio frame 1, the secondary serving cell becomes the muted serving cell. First muted serving cell information is transmitted on the PDCCH of the subframe #0 of the radio frame 1 and a value thereof is 1. Accordingly, the muted serving cell is changed from the muting start point. Since the HARQ process for the PDCCH of the subframe #0 is ended in the radio frame 1, the muting start point is radio frame 2.

Therefore, the user equipment may read the first muted serving cell information and select the muted serving cell as the primary serving cell from the radio frame 2. However, in the radio frame 1, the user equipment still has maintained the muted serving cell as the secondary serving cell.

Meanwhile, in the radio frame 2, the base station sets the band A as the muting bad due to a change of the muted serving cell and the user equipment selects the primary serving cell as the muted serving cell. That is, in the subframes #4, #7, and #8 that belong to the radio frame 2, the primary serving cell becomes the muted serving cell.

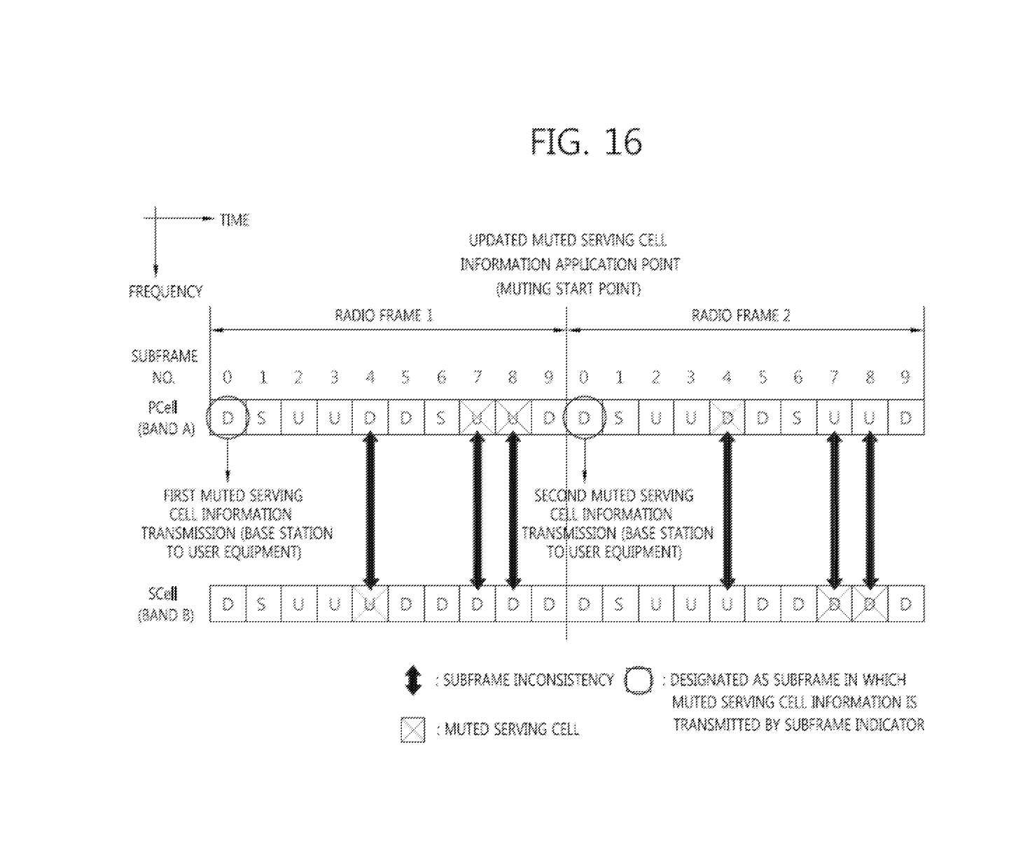

FIG. 16 is an explanatory diagram describing a muted serving cell selection rule according to yet another embodiment of the present invention. This is a rule of selecting the muted serving cell by a scheme of mixing the second embodiment and the fourth embodiment. That is, whenever the muted serving cell information is dynamically changed, the muted serving cell is transmission link-specifically changed.

Referring to FIG. 16, it is assumed that a primary serving cell (PCell) and a secondary serving cell (SCell) that belong to different bands A and B are configured by carrier aggregation, and the TDD uplink/downlink configuration 1 in Table 1 is applied to the primary serving cell and the TDD uplink/downlink configuration 3 in Table 1 is applied to the secondary serving cell. The inconsistent subframes are the subframes #4, #7, and #8 of each radio frame. In addition, the subframe in which the muted serving cell information is transmitted is designated as every subframe #0 by the subframe indicator.

In the radio frame 1, the base station sets the uplink as the muting link. Therefore, since the subframe #4 is constituted by the uplink subframe for the secondary serving cell, the secondary serving cell becomes the muted serving cell. Since the subframes #7 and #8 are constituted by the uplink subframe for the primary serving cell, the primary serving cell becomes the muted serving cell. The first muted serving cell information is transmitted on the PDCCH of the subframe #0 of the radio frame 1 and the value thereof is 1. Accordingly, the muted serving cell is changed from the muting start point. Since the HARQ process for the PDCCH of the subframe #0 is ended in the radio frame 1, the muting start point is radio frame 2.

Meanwhile, in the radio frame 2, the base station sets the downlink as the muting link due to the change of the muted serving cell. Therefore, since the subframe #4 is constituted by the downlink subframe for the primary serving cell, the primary serving cell becomes the muted serving cell. Since the subframes #7 and #8 are constituted by the downlink subframe for the secondary serving cell, the secondary serving cell becomes the muted serving cell.

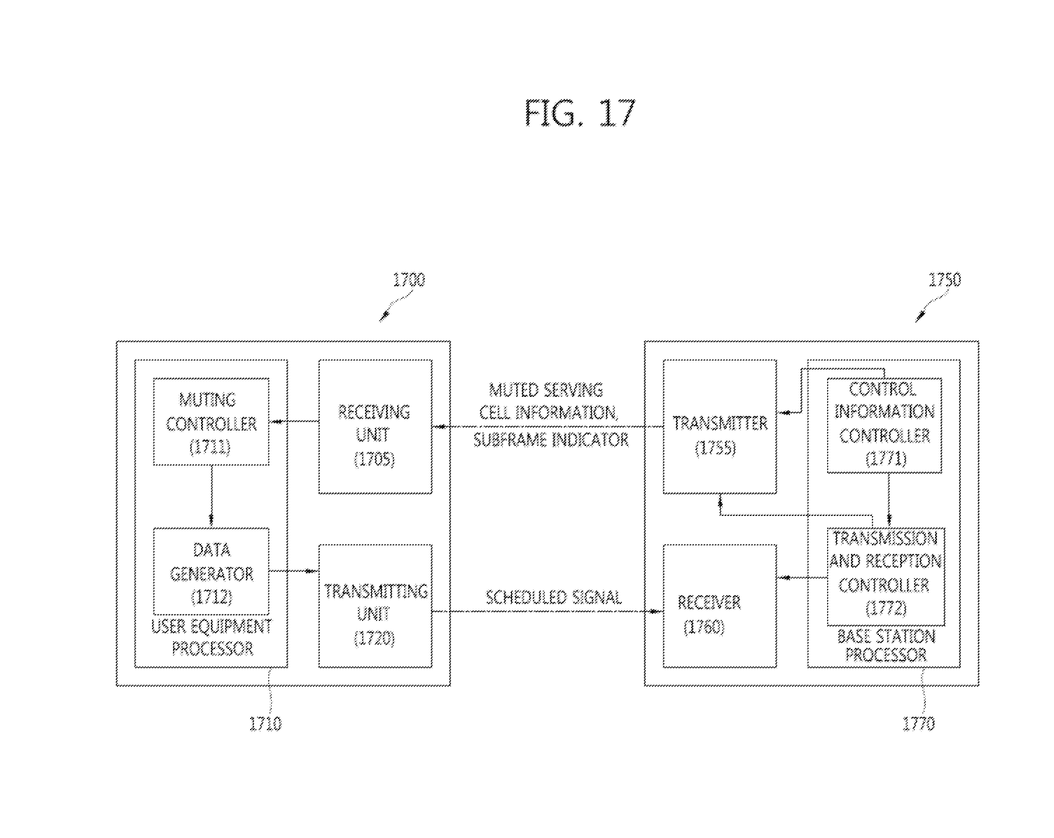

FIG. 17 is a block diagram illustrating a user equipment and a base station according to one example.

Referring to FIG. 17, the user equipment 1700 includes a receiving unit 1705, a user equipment processor 1710, and a transmitting unit 1720. In addition, the user equipment processor 1710 includes a muting control unit 1711 and a data generation unit 1712 again.

The receiving unit 1705 receives muted serving cell information or a subframe indicator from the base station 1750. Further, the receiving unit 1705 receives an RRC message used in an RRC connection setup procedure or an RRC connection reconfiguration procedure. In addition, the receiving unit 1705 converts the muted serving cell information, the subframe indicator, or the RRC message into information which may be recognized by the muting control unit 1711, such as demodulating and decoding the muted serving cell information, the subframe indicator, or the RRC message and thereafter, transfers the converted information to the muting control unit 1711.

The muting control unit 1711 reads the converted information received from the receiving unit 1705, configures a secondary serving cell that belongs to a second band other than a first band to which a primary serving cell belongs by analyzing the muted serving cell information according to the first, second, third, or fourth embodiment, and selects a muted serving cell. The muting control unit 1711 analyzes TDD uplink/downlink configurations applied to a plurality of serving cells constituted in the user equipment 1700 and classifies inconsistent subframes. That is, the muting control unit 1711 may set one of the secondary serving cell and the primary serving cell as the muted serving cell and the other one as an effective serving cell in a predetermined subframe when the predetermined subframe is set by transmission links in different directions with respect to the primary serving cell and the secondary serving cell.

In addition, the muting control unit 1711 calculates a muting start point of stopping (alternatively, holding or dropping) an operation of the muted serving cell, that is, scheduled transmission and reception in the inconsistent subframe, and controls the receiving unit 1705 and the transmitting unit 1720 so that the receiving unit 1705 or the transmitting unit 1720 performs serving cell selective signal reception or transmission every inconsistent subframe from the muting start point. For example, the muting control unit 1711 controls the receiving unit 1705 so as not to perform the scheduled reception in the muted serving cell and controls the transmitting unit 1720 so as not to perform the scheduled transmission.

The data generation unit 1712 generates scheduled data and transfers the generated scheduled data to the transmitting unit 1720.

The transmitting unit 1720 performs signal processing such as modulating and encoding the scheduled data received from the data generation unit 1712 and converts the scheduled data into a transmittable signal and thereafter, transmits the converted signal to the base station 1750.

The base station 1750 includes a transmitter 1755, a receiver 1760, and a base station processor 1770. The base station processor 1770 includes a control information generator 1771 and a transmission and reception controller 1772.

The transmitter 1755 performs signal processing such as modulating and encoding scheduled data, muted serving cell information, or a subframe indicator received from the control information generator 1771 and converts the scheduled data, muted serving cell information, or subframe indicator into a transmittable signal and thereafter, transmits the converted signal to the user equipment 1700.

The receiver 1760 receives a scheduled signal from the user equipment 1700, and performs inverse signal processing of demodulating and decoding the scheduled signal in order to convert the scheduled signal into information which may be processed by the base station processor 1770.

The control information generator 1771 generated muted serving cell information and sends the generated muted serving cell information to the transmitter 1755 and the transmission and reception controller 1772.

As one example, the control information generator 1771 may encapsulate the muted serving cell information in a TDD configuration information element. The TDD configuration information element may have, for example, any one format in Tables 4 to 7. Meanwhile, the control information generator 1771 may encapsulate the TDD configuration information element including the muted serving cell information in the RRC message used for the RRC connection reconfiguration shown in Table 2 or a system information block 1 shown in Table 3.

As another example, the control information generator 1771 may encapsulate the muted serving cell information in a new-format DCI. The new-format DCI may be configured as shown in, for example, Table 8.

Meanwhile, the control information generator 1771 generates the subframe indicator. The control information generator 1771 may encapsulate the subframe indicator in higher layer signaling, for example, the RRC message. The subframe indicator may indicate any one subframe of the subframes #0, #1, #5, and #6 as 2 bits. Alternatively, the subframe indicator may have a cycle and an offset. Alternatively, the subframe indicator may indicate at least one subframe in a bitmap format every radio frame. In addition, the control information generator 1771 may update the subframe indicator.

The transmission and reception controller 1772 selects the muted serving cell by analyzing the muted serving cell information received from the control information generator 1771 according to the first, second, third, or fourth embodiment. For example, the transmission and reception controller 1772 sets one of the secondary serving cell and the primary serving cell as the muted serving cell and the other one as an effective serving cell in a predetermined subframe when the predetermined subframe is set by transmission links in different directions with respect to the primary serving cell and the secondary serving cell.

In addition, the transmission and reception controller 1772 analyzes TDD uplink/downlink configurations applied to a plurality of serving cells constituted in the user equipment 1700 and classifies inconsistent subframes. In addition, the muting controller 1772 calculates a muting start point of stopping (alternatively, holding or dropping) an operation of the muted serving cell, that is, scheduled transmission and reception in the inconsistent subframe, and controls the receiver 1760 and the transmitter 1755 so that the receiver 1760 or the transmitter 1755 performs serving cell selective signal reception or transmission every inconsistent subframe from the muting start point.

Various exemplary embodiments of the present invention have been just exemplarily described, and various changes and modifications may be made by those skilled in the art to which the present invention pertains without departing from the scope and spirit of the present invention. Accordingly, the various embodiments disclosed herein are not intended to limit the technical spirit but describe with the true scope and spirit being indicated by the following claims. The scope of the present invention may be interpreted by the appended claims and all the technical spirits in the equivalent range thereto are intended to be embraced by the claims of the present invention.

1. A method for cell-selectively transceiving a signal by a user equipment in a multiple element carrier system in which an uplink and a downlink are subjected to time division duplex (TDD) by the unit of a subframe, the method comprising:
configuring a secondary serving cell which belongs to a second band other than a first band to which a primary serving cell belongs;
setting one of the secondary serving cell and the primary serving cell as a muted serving cell and the other one as an effective serving cell in a predetermined subframe when the predetermined subframe is set by transmission links in different directions with respect to the primary serving cell and the secondary serving cell; and
performing transmission and reception of a signal on the set effective serving cell.

2. The method of claim 1, further comprising:
receiving from a base station a radio resource control (RRC) which makes the secondary serving cell to be configured in the user equipment,
wherein the RRC message includes muted serving cell information which indicates that the first band includes the muted serving cell or the effective serving cell, and
wherein one of the secondary serving cell and the primary serving cell is set as the muted serving cell and the other one is set as the effective serving cell based on the muted serving cell information.

3. The method of claim 1, further comprising:
receiving from the base station the RRC message which makes the secondary serving cell to be configured in the user equipment,
wherein the RRC message includes muted serving cell information which indicates a transmission link in a specific direction, and
wherein the setting of the muted serving cell and the effective serving cell includes setting one of the secondary serving cell and the primary serving cell, which is set by the transmission link in the specific direction as the effective serving cell.

4. The method of claim 1, further comprising:
receiving from the base station the RRC message which makes the secondary serving cell to be configured in the user equipment,
wherein the RRC message includes bitmap information which explicitly indicates the muted serving cell in the predetermined subframe, and
wherein one of the secondary serving cell and the primary serving cell is set as the muted serving cell and the other one is set as the effective serving cell based on the bitmap information.

5. The method of claim 1, further comprising:
receiving from the base station downlink control information including muted serving cell information which indicates maintaining or changing the muted serving cell through a physical downlink control channel (PDCCH),
wherein the muted serving cell information is 1 bit, the muted serving cell information is received in a downlink subframe which is predesignated before the predetermined subframe, and the downlink subframe is predesignated by the RRC message.

6. The method of claim 5, wherein:
the predesignated downlink subframe is any one of subframes at positions defined as the downlink subframe commonly in both a first TDD uplink/downlink configuration for the primary serving cell and a second TDD uplink/downlink configuration for the secondary serving cell.

7. The method of claim 6, further comprising:
receiving muted serving cell information which indicates a third TDD uplink/downlink configuration,
wherein the setting of the effective serving cell includes setting as the effective serving cell one of the secondary serving cell and the primary serving cell, which is a transmission link in the same direction as the third uplink/downlink configuration in the predetermined subframe.

8. A user equipment to cell-selectively transceive a signal a in a multiple element carrier system in which an uplink and a downlink are subjected to time division duplex (TDD) by the unit of a subframe, the user equipment comprising:
a muting control unit to configure a secondary serving cell which belongs to a second band other than a first band to which a primary serving cell belongs, and to set one of the secondary serving cell and the primary serving cell as a muted serving cell and the other one as an effective serving cell in a predetermined subframe when the predetermined subframe is set by transmission links in different directions with respect to the primary serving cell and the secondary serving cell;
a data generation unit to generate scheduled data; and
a transmitting unit to transmit the scheduled data on the set effective serving cell.

9. The user equipment of claim 8, further comprising:
a receiving unit to receive, from a base station, a radio resource control (RRC) which makes the secondary serving cell to be configured in the user equipment,
wherein the RRC message includes muted serving cell information which indicates that the first band includes the muted serving cell or the effective serving cell, and
the muting control unit sets one of the secondary serving cell and the primary serving cell as the muted serving cell and the other one as the effective serving cell based on the muted serving cell information.

10. The user equipment of claim 8, further comprising:
a receiving unit to receive, from the base station, the RRC message which makes the secondary serving cell to be configured in the user equipment,
wherein the RRC message includes muted serving cell information which indicates a transmission link in a specific direction, and
the muting control unit sets one of the secondary serving cell and the primary serving cell, which is set by the transmission link in the specific direction as the effective serving cell.

11. A method for cell-selectively transceiving a signal by a base station in a multiple element carrier system in which an uplink and a downlink are subjected to time division duplex by the unit of a subframe, the method comprising:
transmitting a radio resource control (RRC) message which makes a secondary serving cell that belongs to a second band other than a first band to which a primary serving cell belongs in a user equipment and muted serving cell information, to the user equipment;
setting one of the secondary serving cell and the primary serving cell as a muted serving cell and the other one as an effective serving cell in a predetermined subframe based on the muted serving cell information when the predetermined subframe is set by transmission links in different directions with respect to the primary serving cell and the secondary serving cell; and
performing transmission and reception of a scheduled signal on the effective serving cell.

12. The method of claim 11, wherein the muted serving cell information indicates which the first band includes the muted serving cell or the effective serving cell, and
wherein one of the secondary serving cell and the primary serving cell is set as the muted serving cell and the other one is set as the effective serving cell based on the muted serving cell information.

13. The method of claim 11, wherein the muted serving cell information indicates a transmission link in a specific direction, and
wherein the setting of the muted serving cell and the effective serving cell includes setting one of the secondary serving cell and the primary serving cell, which is set by the transmission link in the specific direction as the effective serving cell.

14. The method of claim 11, wherein the muted serving cell information is bitmap information which explicitly indicates that the muted serving cell in the predetermined subframe, and
wherein one of the secondary serving cell and the primary serving cell is set as the muted serving cell and the other one is set as the effective serving cell.

15. The method of claim 11, wherein
the muted serving cell information indicates maintaining or changing the muted serving cell, downlink control information is transmitted to the user equipment through a physical downlink control channel (PDCCH), the muted serving cell information is 1 bit, the muted serving cell information is transmitted in a downlink subframe which is predesignated before the predetermined subframe, and the downlink subframe is predesignated by the RRC message.

16. The method of claim 15, wherein the predesignated downlink subframe is any one of subframes at positions defined as the downlink subframe commonly in both a first time division duplex (TDD) uplink/downlink configuration for the primary serving cell and a second TDD uplink/downlink configuration for the secondary serving cell.

17. The method of claim 16, wherein the muted serving cell information indicates a third TDD uplink/downlink configuration, and
wherein the setting of the muted serving cell and the effective serving cell includes setting as the effective serving cell one of the secondary serving cell and the primary serving cell, which is a transmission link in the same direction as the third uplink/downlink configuration in the predetermined subframe.

18. A base station for cell-selectively transceiving a signal in a multiple element carrier system in which an uplink and a downlink are subjected to time division duplex (TDD) by the unit of a subframe, the base station comprising:
a control information generator to generate a radio resource control (RRC) message which makes a secondary serving cell that belongs to a second band other than a first band to which a primary serving cell belongs in a user equipment and muted serving cell information, to the user equipment;
a transmitter to transmit the RRC message and the muted serving cell information to the user equipment;
a transmission and reception controller to set one of the secondary serving cell and the primary serving cell as a muted serving cell and the other one as an effective serving cell in a predetermined subframe based on the muted serving cell information when the predetermined subframe is set by transmission links in different directions with respect to the primary serving cell and the secondary serving cell; and
a receiver to perform reception of a scheduled signal on the effective serving cell.

19. The base station of claim 18, wherein the control information generator generates the muted serving cell information which indicates that the first band includes the muted serving cell or the effective serving cell, and
wherein the transmission and reception controller sets one of the secondary serving cell and the primary serving cell as the muted serving cell and the other one as the effective serving cell based on the muted serving cell information.

20. The base station of claim 18, wherein the control information generator generates the muted serving cell information which indicates a transmission link in a specific direction, and
wherein the transmission and reception controller sets one of the secondary serving cell and the primary serving cell, which is set by the transmission link in the specific direction as the effective serving cell.
